(19) United States
(12) Patent Application Publication
(10) Pub. No.: US 2024/0402824 A1
(43) Pub. Date: Dec. 5, 2024

(54) Manipulating a Rig Based on an Interaction in a Physical Environment

(71) Applicant: Apple Inc., Cupertino, CA (US)

(72) Inventors: Alexander Wells, Berkeley, CA (US); Eric G. Thivierge, Merchantville, NJ (US)

(21) Appl. No.: 18/670,598

(22) Filed: May 21, 2024

Related U.S. Application Data
(60) Provisional application No. 63/470,508, filed on Jun. 2, 2023.

(51) Int. Cl. G06F 3/01; G06T 13/40

(52) U.S. Cl. CPC G06F 3/017; G06F 3/013; G06T 13/40

(57) ABSTRACT

A method includes while displaying a rig on the display, detecting a gesture that corresponds to a request to manipulate the rig. The method includes in response to detecting the gesture, obtaining, via the one or more sensors, interaction data that characterizes an interaction of a user of the electronic device in a physical environment of the electronic device. The method includes manipulating the rig in accordance with a first manipulation when the interaction data satisfies a first interaction criterion. The method includes manipulating the rig in accordance with a second manipulation when the interaction data satisfies a second interaction criterion.

### CROSS-REFERENCE TO RELATED APPLICATION

This application claims the benefit of U.S. Provisional Patent App. No. 63/470,508, filed on Jun. 2, 2023, which is incorporated by reference in its entirety.

### TECHNICAL FIELD

The present disclosure generally relates to manipulating a rig based on an interaction in a physical environment.

### BACKGROUND

Some devices include a display that can display a rig. The rig may be associated with a virtual object such as a virtual character. A user of the device may manipulate the rig by providing a user input. Some rigs may be capable of various manipulations.

### BRIEF DESCRIPTION OF THE DRA WINGS

So that the present disclosure can be understood by those of ordinary skill in the art, a more detailed description may be had by reference to aspects of some illustrative implementations, some of which are shown in the accompanying drawings.

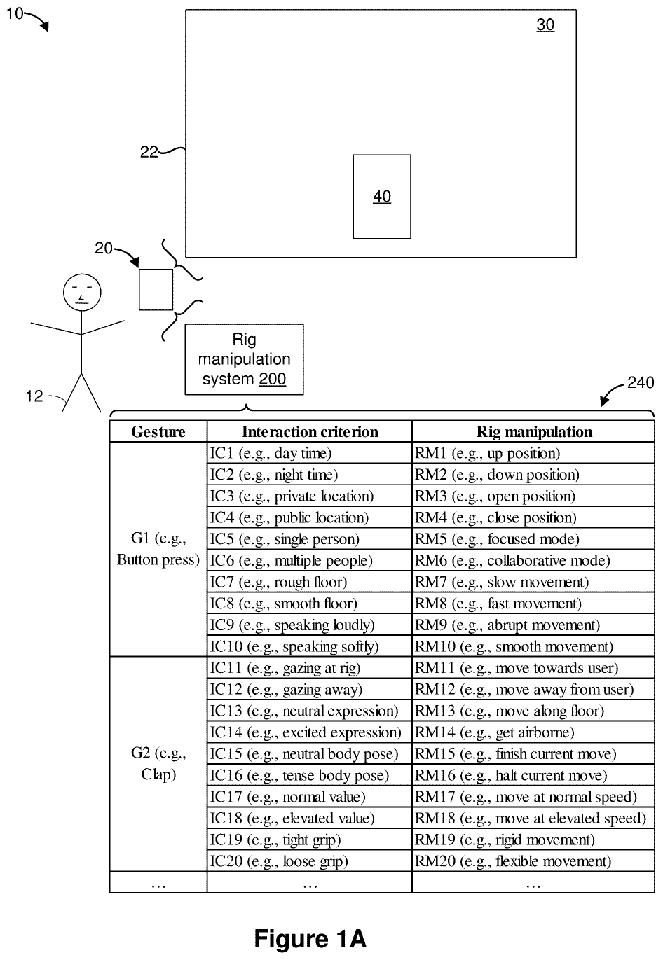

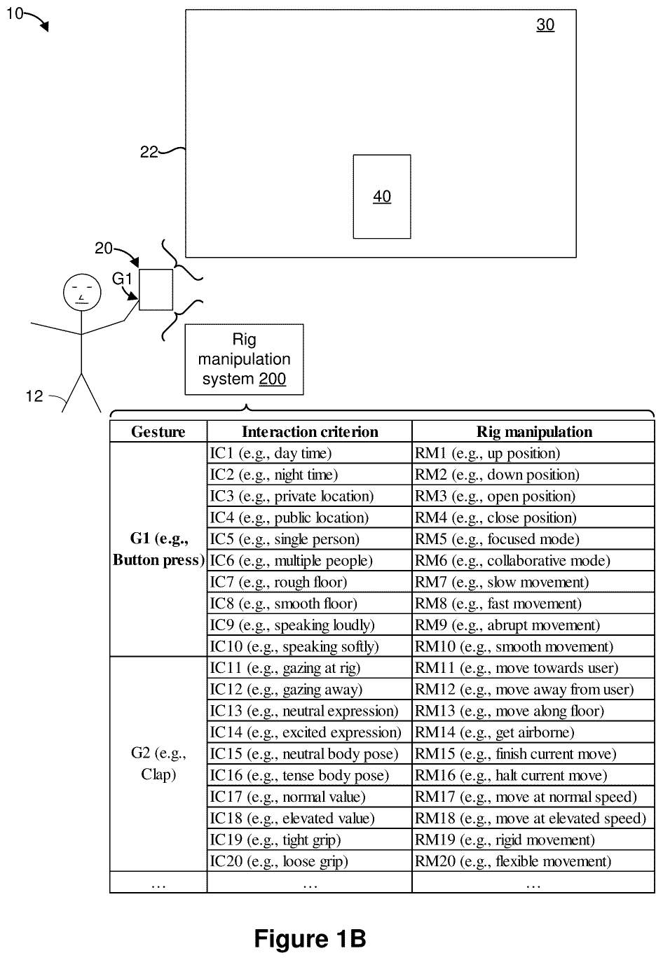

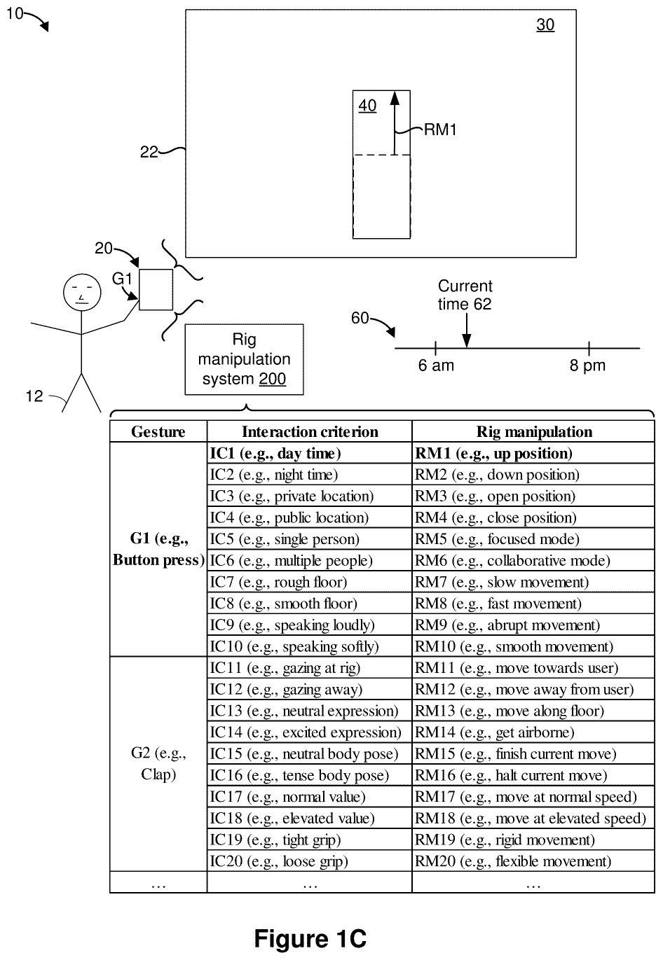

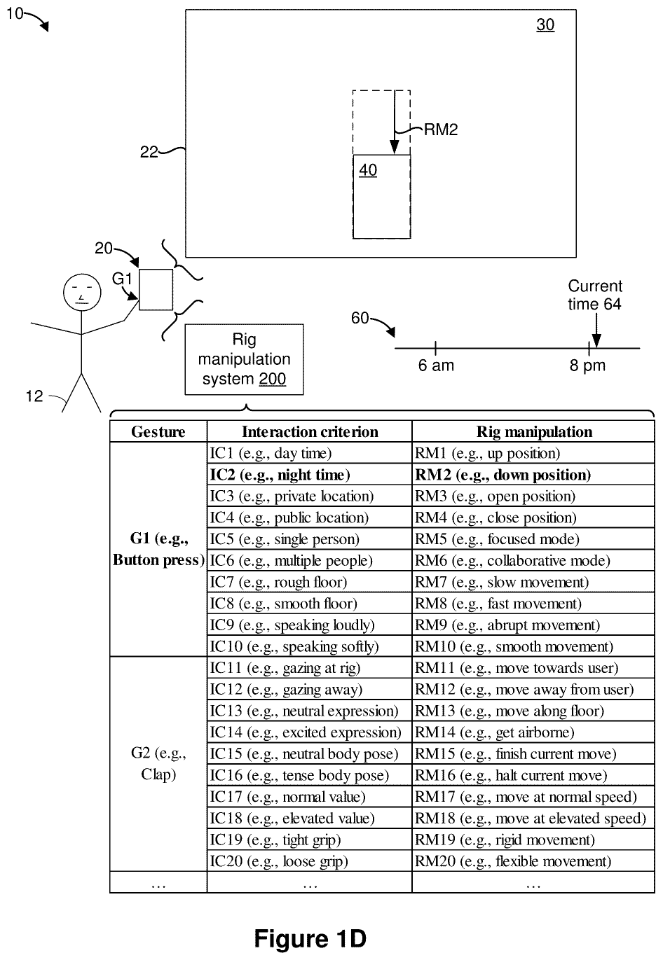

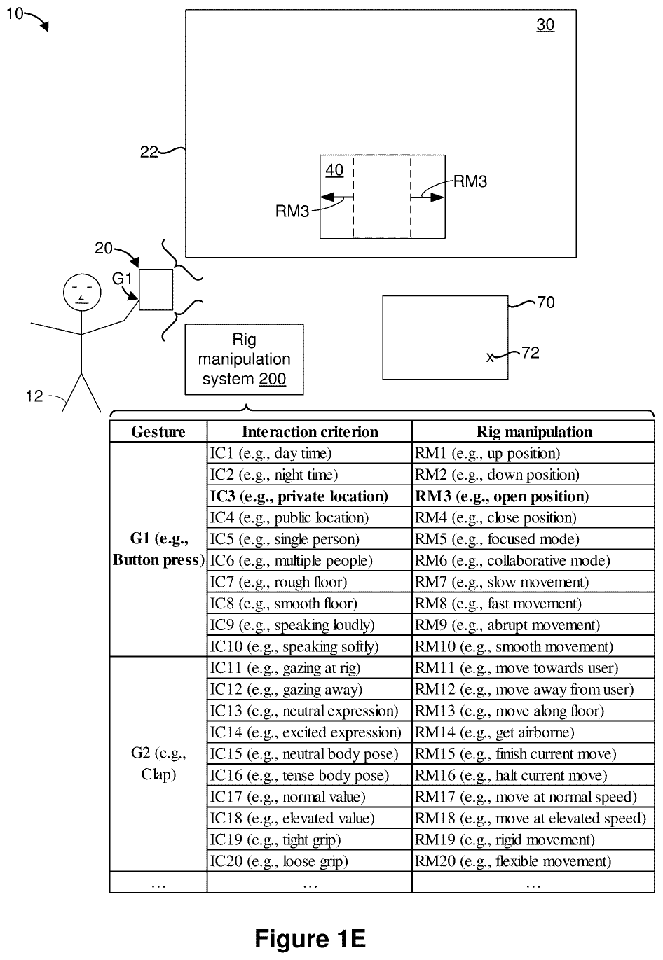

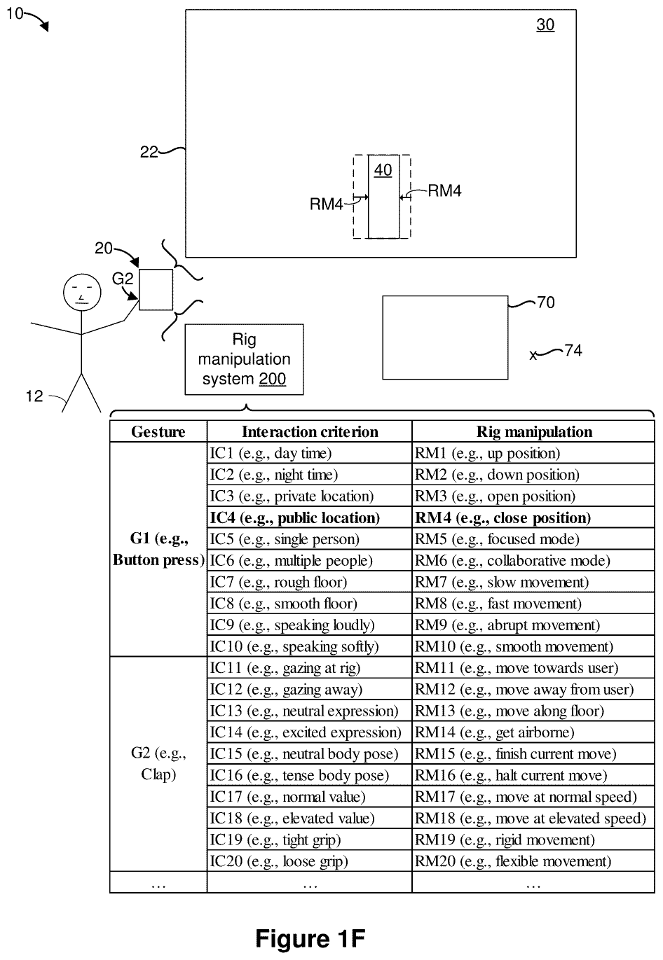

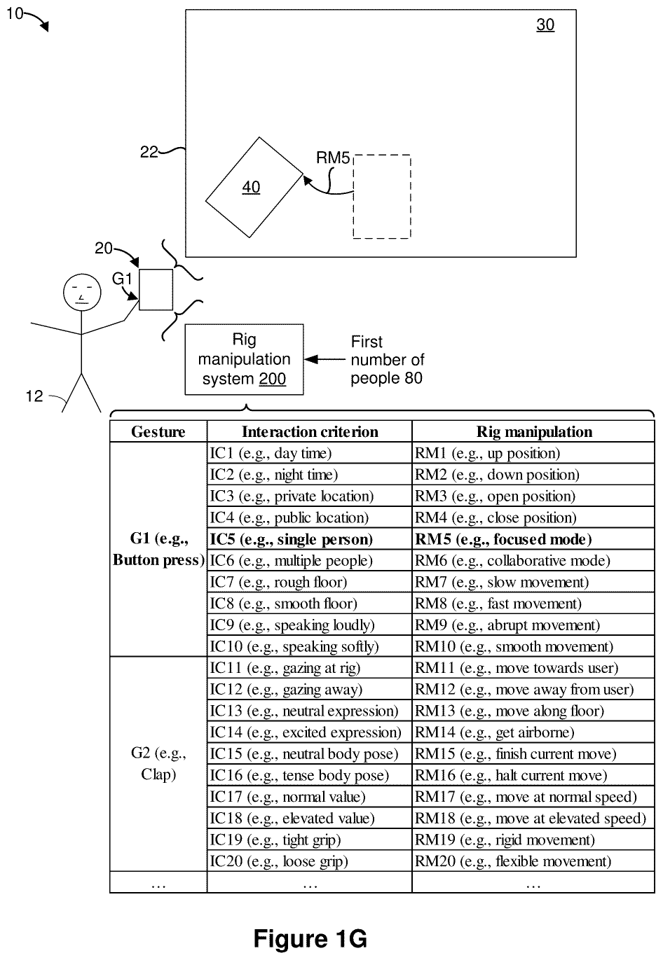

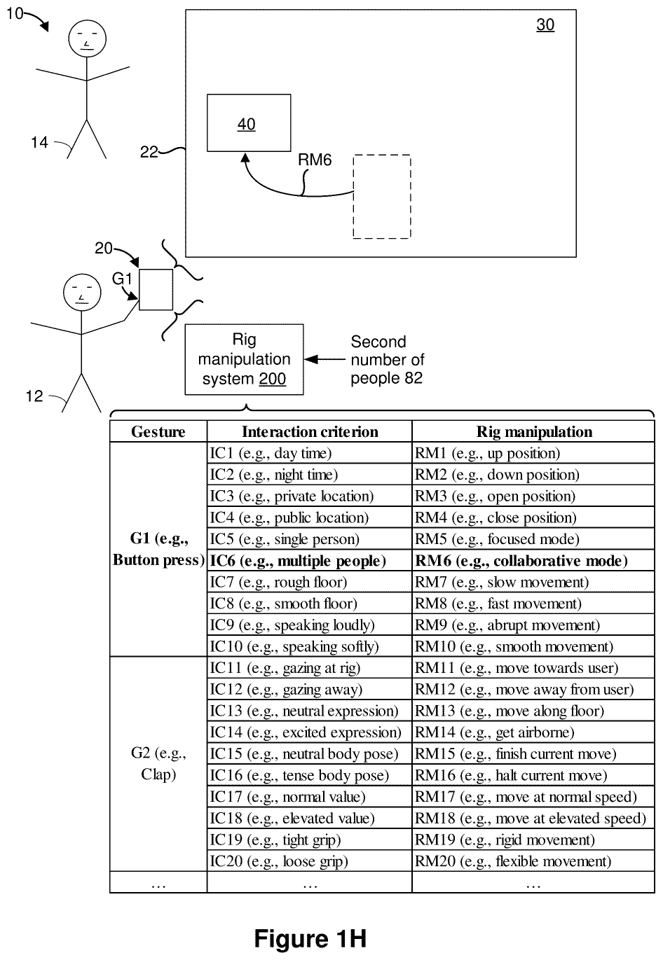

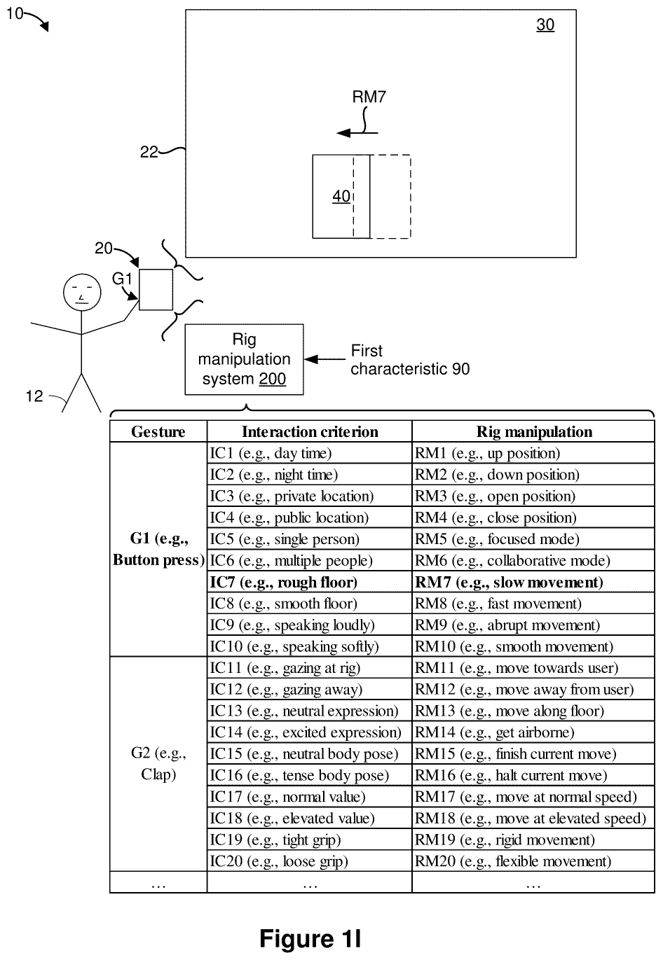

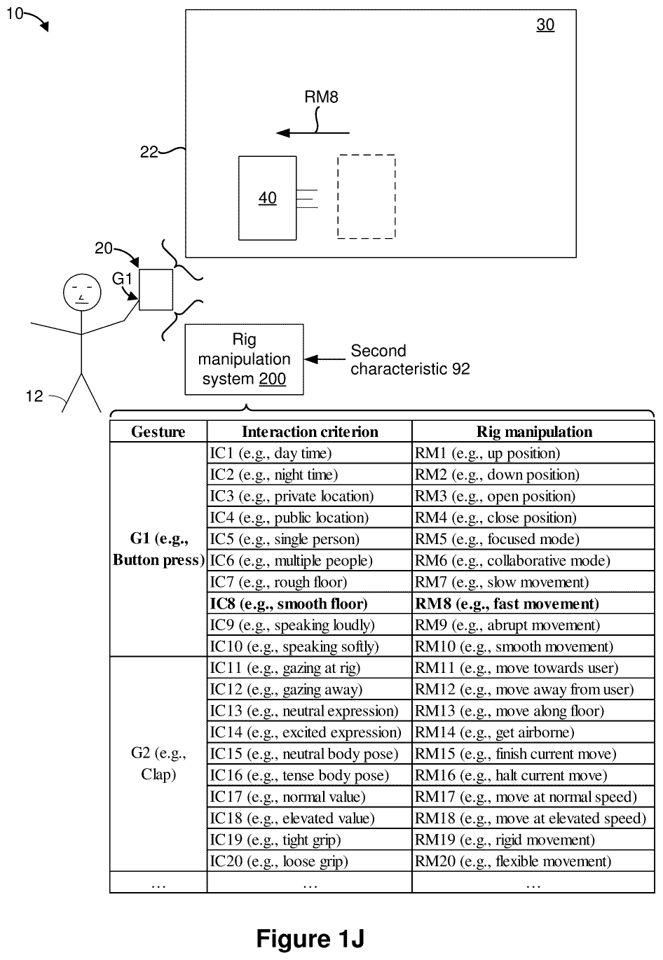

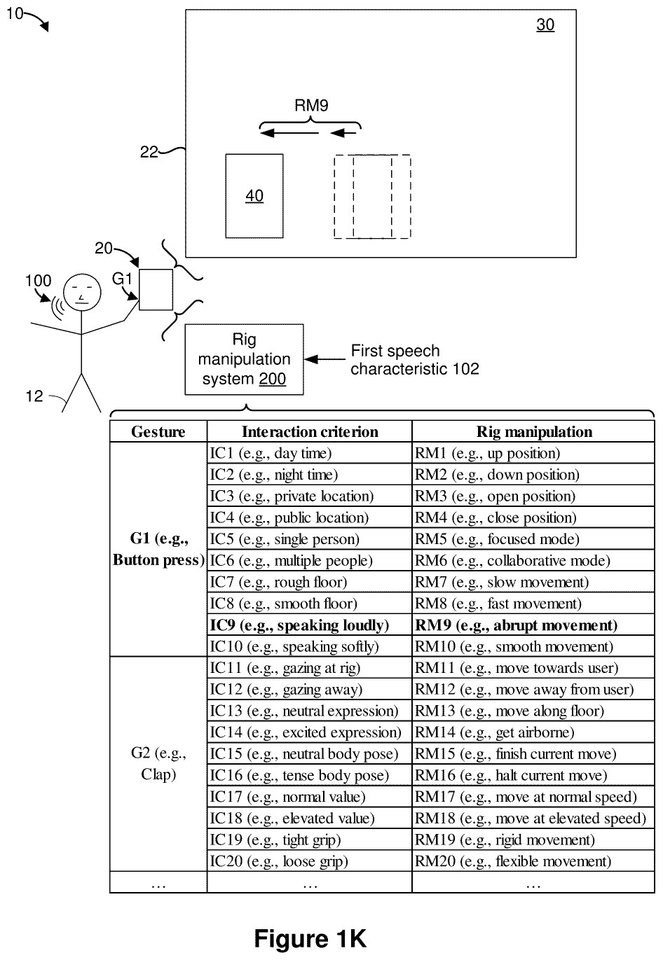

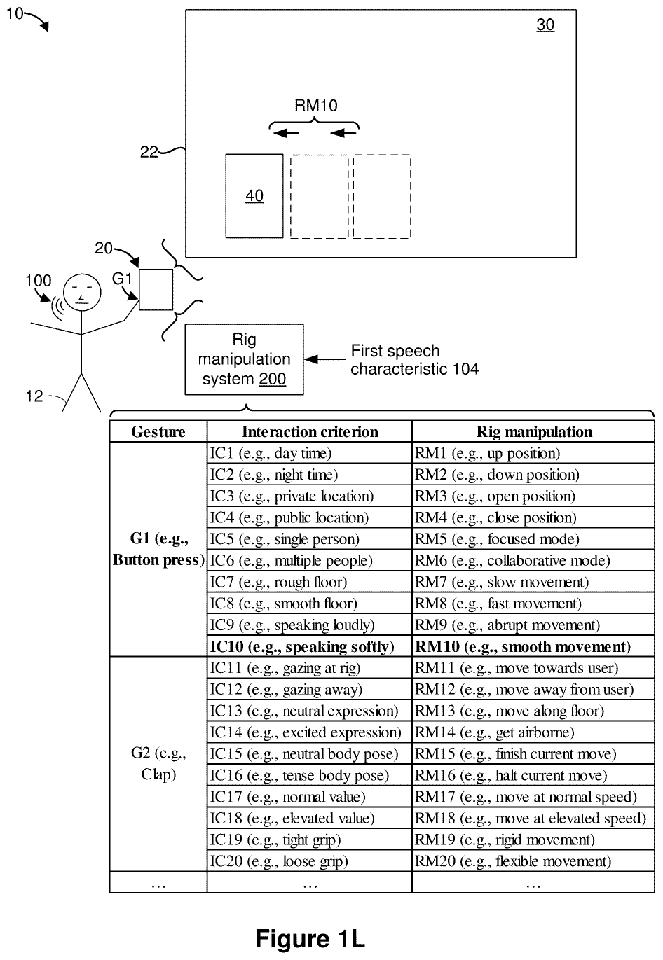

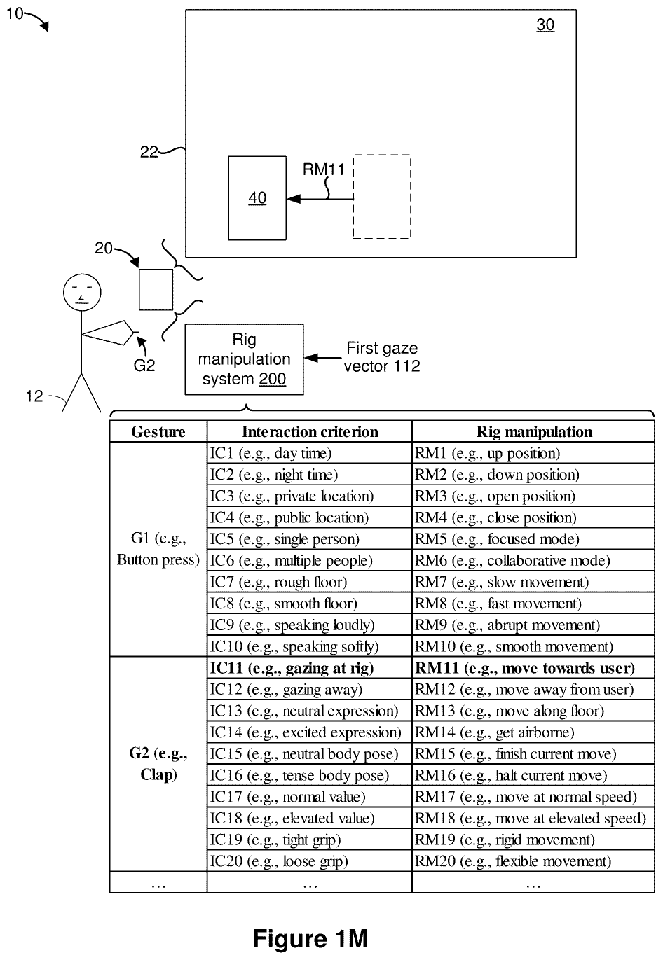

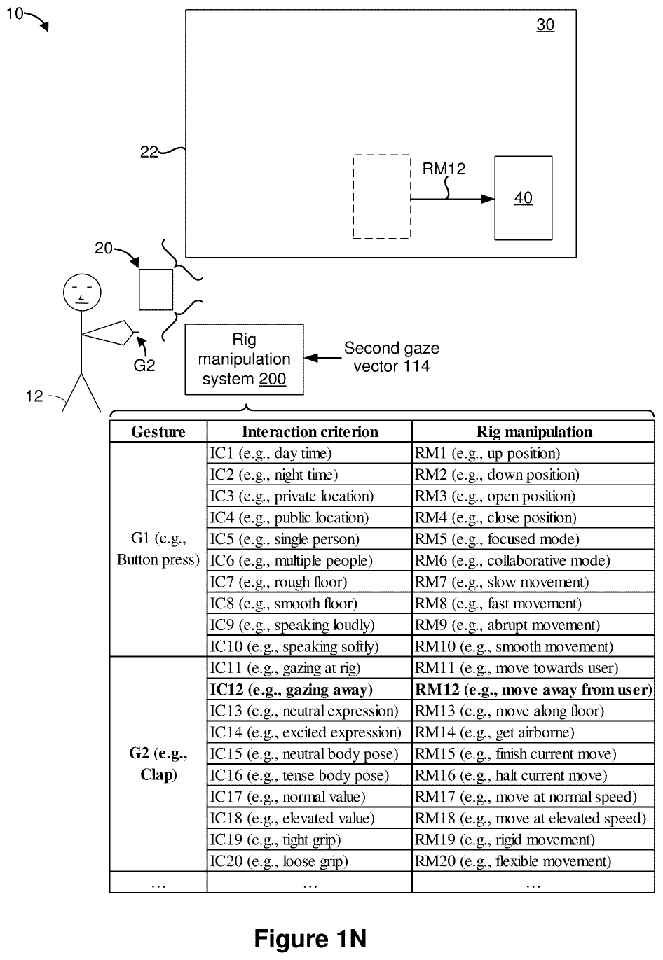

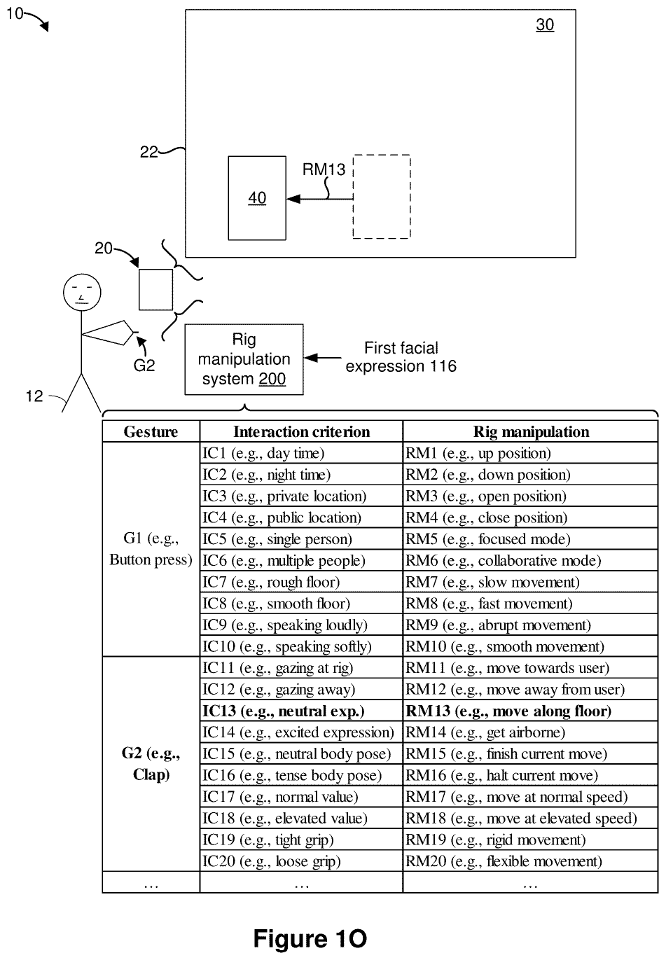

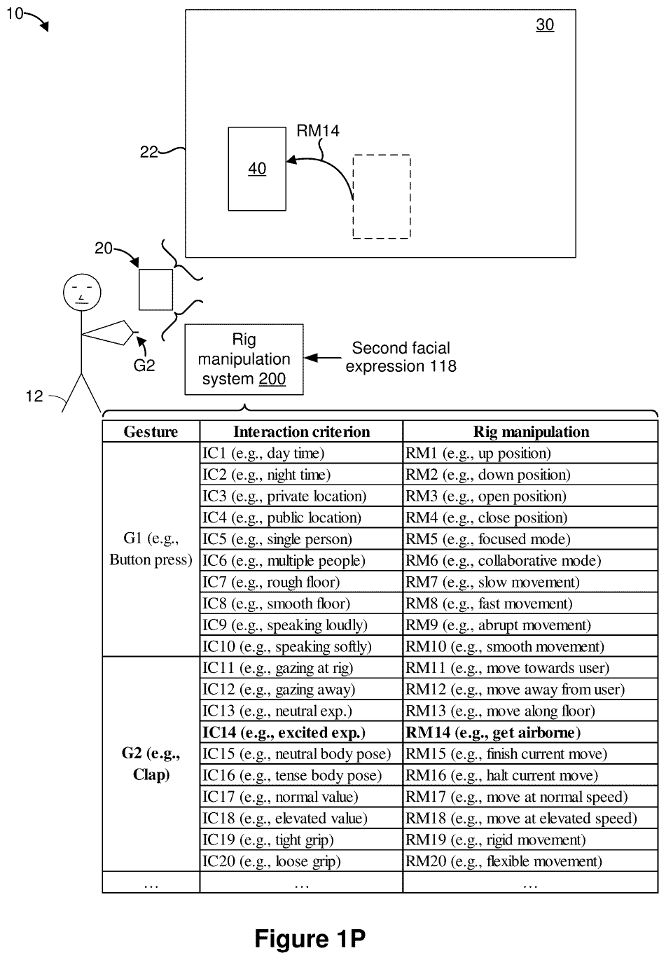

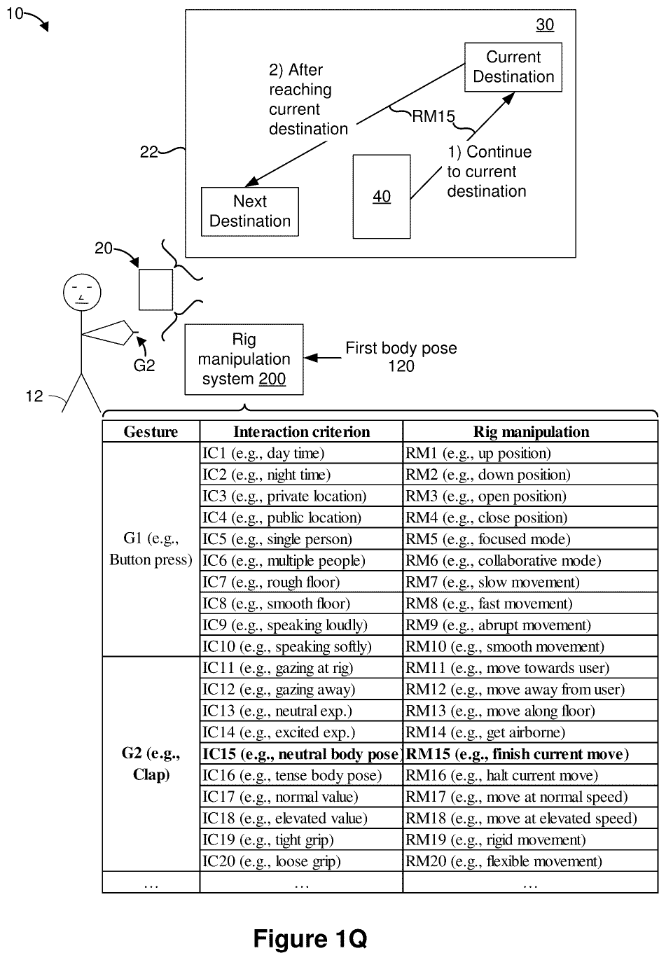

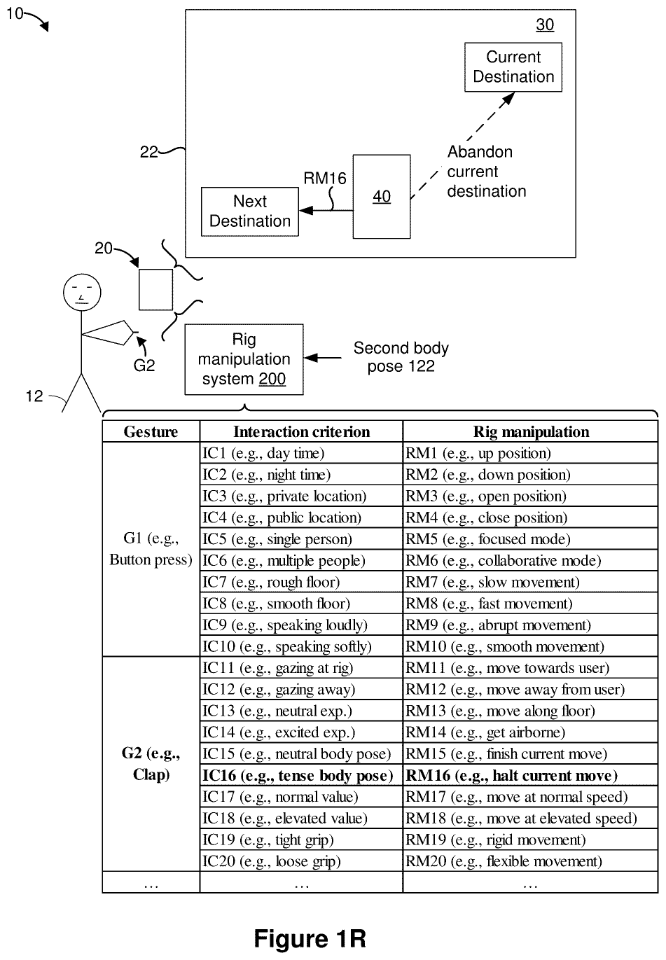

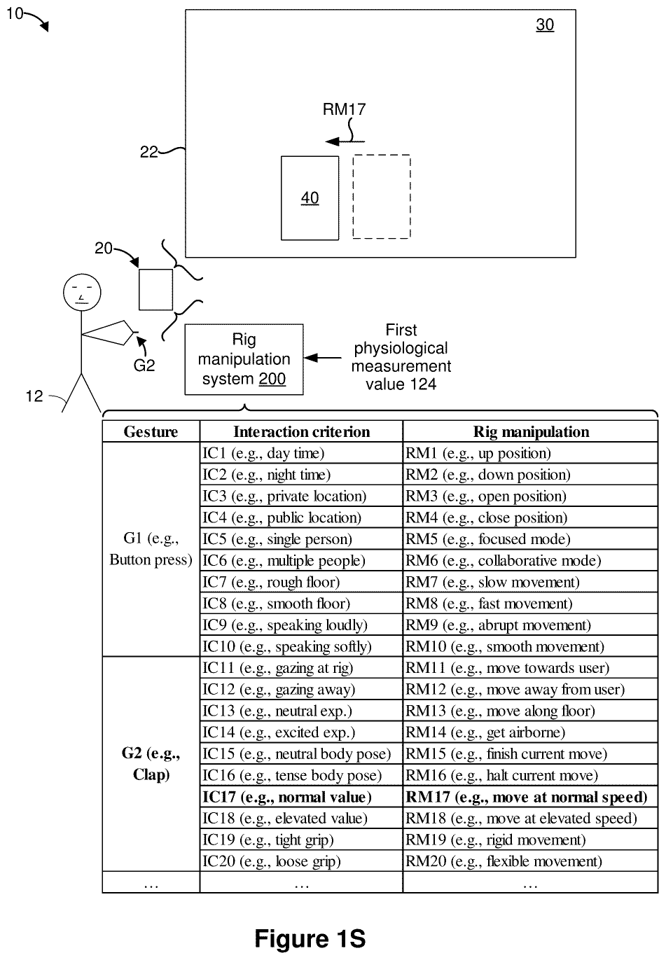

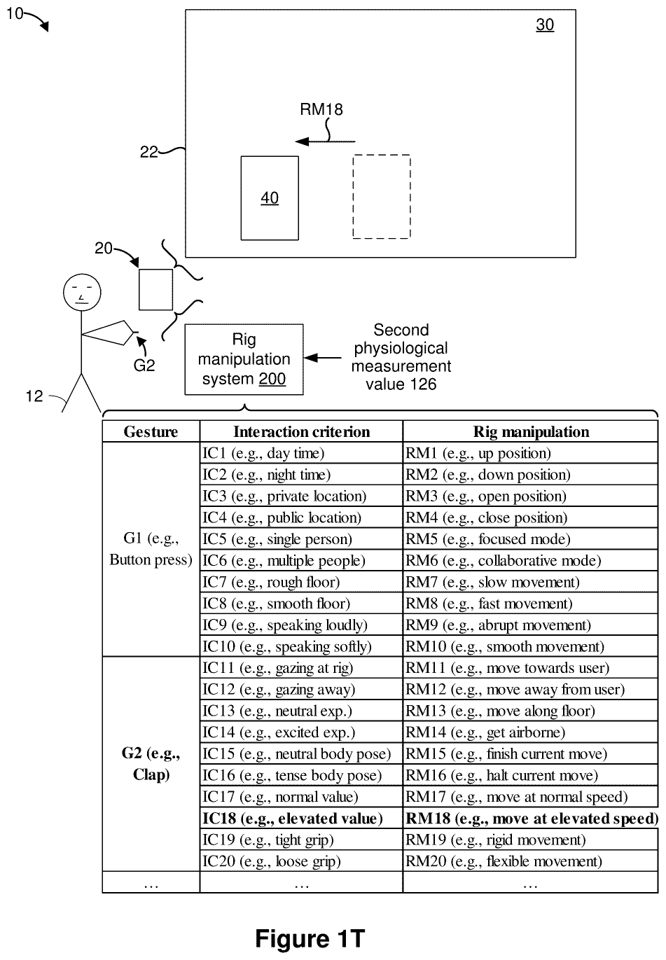

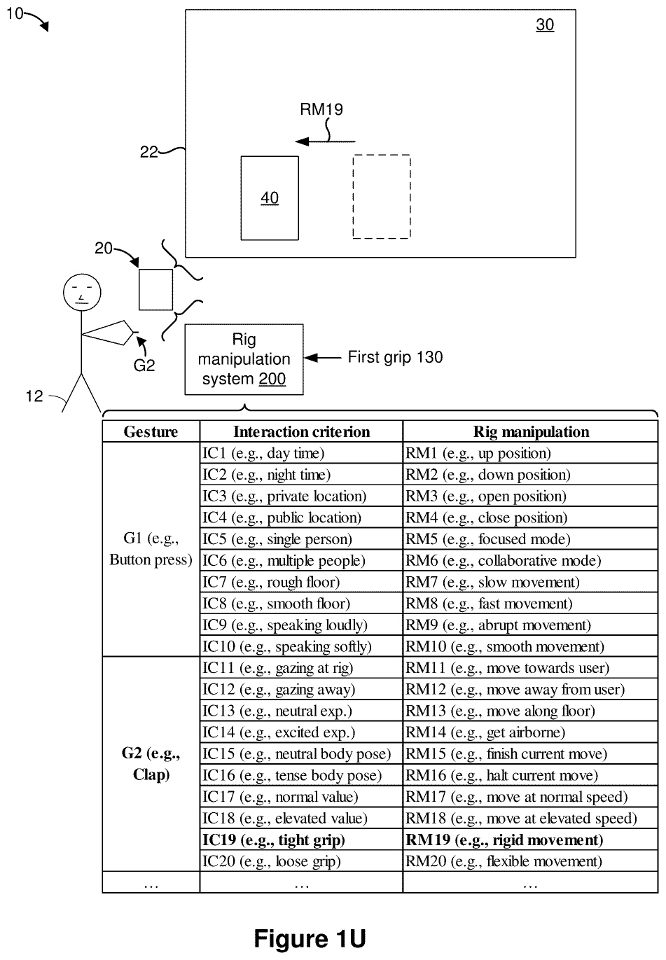

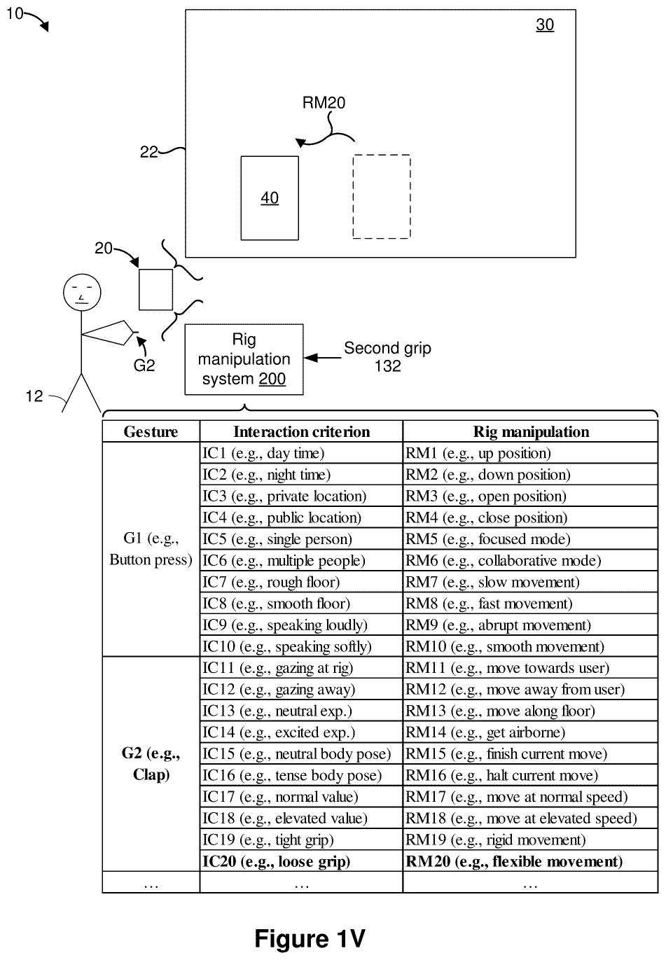

FIGS. 1A-1V are diagrams of an example operating environment in accordance with some implementations.

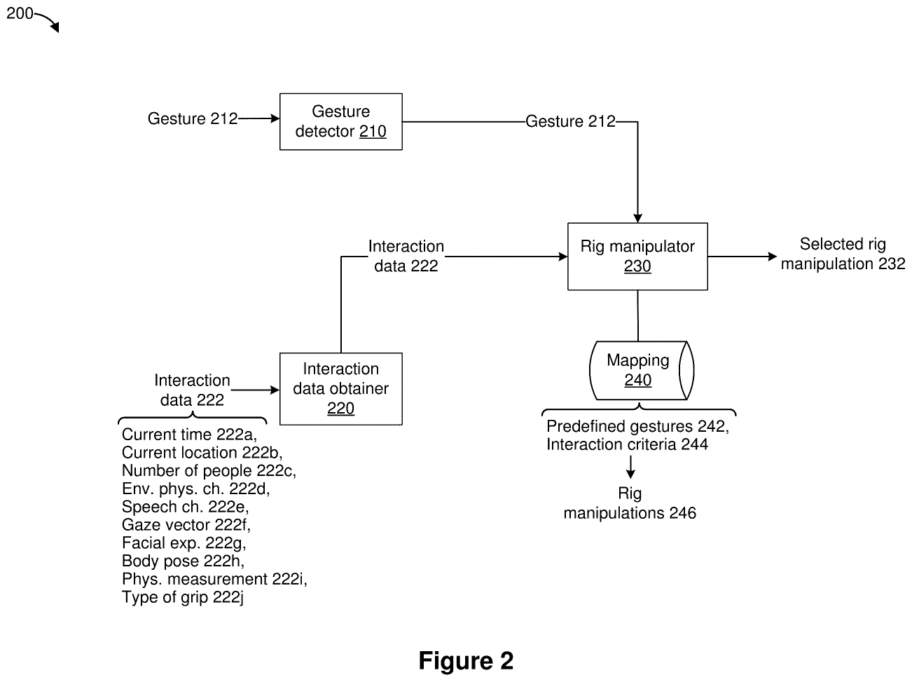

FIG. 2 is a diagram of a rig manipulation system in accordance with some implementations.

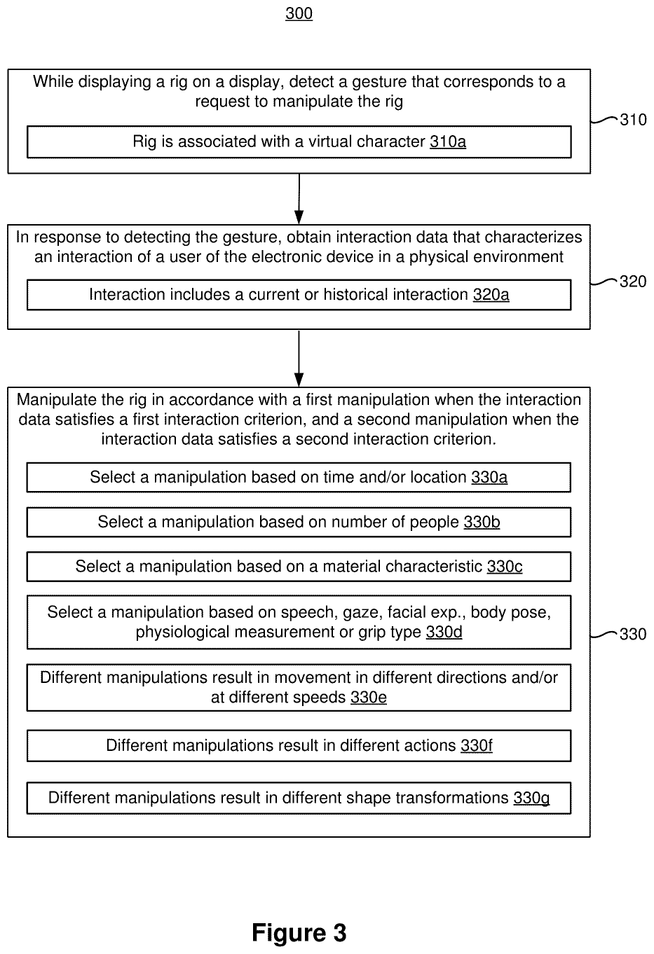

FIG. 3 is a flowchart representation of a method of manipulating a rig based on a gesture and a real-world interaction in accordance with some implementations.

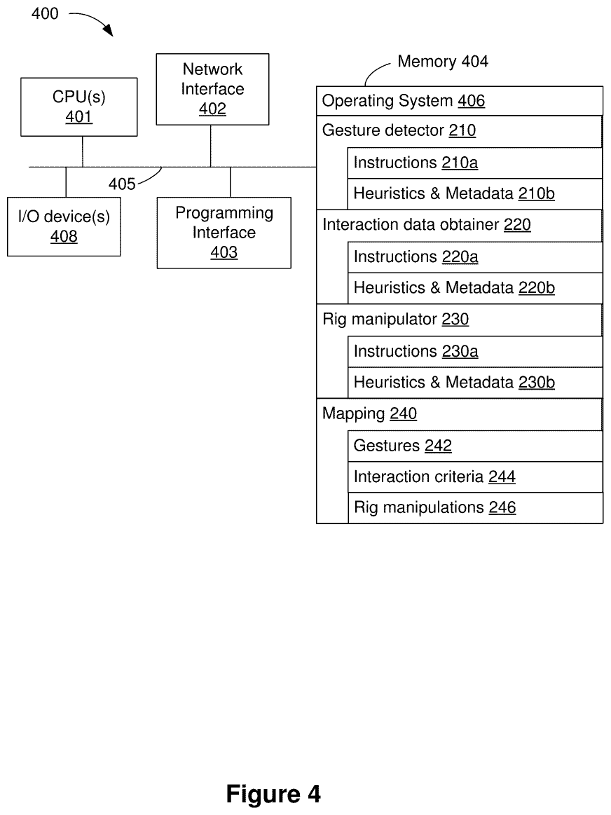

FIG. 4 is a block diagram of a device that manipulates a rig based on a gesture and a real-world interaction in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and methods for manipulating a rig based on a gesture and an interaction in a physical environment. In some implementations, a method is performed by an electronic device including a non-transitory memory, one or more processors, a display and one or more sensors. In various implementations, a method includes while displaying a rig on the display, detecting a gesture that corresponds to a request to manipulate the rig. In some implementations, the method includes in response to detecting the gesture, obtaining, via the one or more sensors, interaction data that characterizes an interaction of a user of the electronic device in a physical environment of the electronic device. In some implementations, the method includes manipulating the rig in accordance with a first manipulation when the interaction data satisfies a first interaction criterion. In some implementations, the method includes manipulating the rig in accordance with a second manipulation when the interaction data satisfies a second interaction criterion.

In accordance with some implementations, a device includes one or more processors, a plurality of sensors, a non-transitory memory, and one or more programs. In some implementations, the one or more programs are stored in the non-transitory memory and are executed by the one or more processors. In some implementations, the one or more programs include instructions for performing or causing performance of any of the methods described herein. In accordance with some implementations, a non-transitory computer readable storage medium has stored therein instructions that, when executed by one or more processors of a device, cause the device to perform or cause performance of any of the methods described herein. In accordance with some implementations, a device includes one or more processors, a non-transitory memory, and means for performing or causing performance of any of the methods described herein.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

Some rigs can be manipulated based on a user input. However, a creator of the rig usually has to define which user inputs lead to what type of manipulations. Defining different user inputs for each manipulation that the rig can perform can be resource intensive. Moreover, there is typically a 1-to-1 mapping between user inputs and manipulations. Hence, each user input leads to a single predefined manipulation of the rig. If the rig is capable of numerous manipulations that are triggered by different user inputs, then the device may have to be trained to detect each of the user inputs associated with the numerous manipulations and the user of the device may have to remember each of the user inputs to trigger the numerous manipulations. If the user forgets a user input for triggering a particular manipulation, then the user may not be able to manipulate the rig according to that particular manipulation.

The present disclosure provides methods, systems, and/or devices for manipulating a rig in different manners based on a gesture and different interactions in a physical environment. A device detects a gesture that corresponds to a request to manipulate a rig. Upon detecting the gesture, the device obtains interaction data that indicates an interaction of a user in a physical environment of the device. Different interactions trigger the device to manipulate the rig in different manners even though the user performed the same gesture.

The interaction data allows the device to perform interaction-aware manipulations, so that a behavior of the rig changes based on an interaction of the user with the physical environment of the device. With interaction-aware manipulations, the same gesture can result in different manipulations of the rig based on real-world interactions of the user of the device. Since the same gesture can lead to different potential manipulations, each manipulation does not have to be triggered by a separate gesture. As such, the device does not have to be trained to detect numerous gestures. Instead, the device can be trained to detect a limited set of gestures and the device can perform different manipulations of the rig based on the detected gesture and the real-world interaction. Moreover, the user does not need to remember different gestures for each manipulation. The user can remember a limited set of gestures and rely on the device to trigger the appropriate manipulation of the rig based on the real-world interaction of the user of the device.

FIG. 1A is a diagram that illustrates an example physical environment 10 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the physical environment 10 includes a user 12, an electronic device 20 and a rig manipulation system 200. In some implementations, the electronic device 20 includes (e.g., implements) the rig manipulation system 200. Alternatively, in some implementations, the rig manipulation system 200 is separate from the electronic device 20. In some implementations, the electronic device 20 includes a handheld computing device such as a smartphone, a tablet, a laptop or a media player. Alternatively, in some implementations, the electronic device 20 includes a wearable computing device such as a watch or a head-mountable device (HMD). In some implementations, the electronic device 20 is capable of detecting a limited number of gestures. For example, the electronic device 20 may be an HMD that primarily relies on an image sensor to detect three-dimensional (3D) gestures that the user 12 makes with his/her hands (e.g., the HMD may not include a touchscreen that the user 12 can use to provide touch inputs).

In various implementations, the electronic device 20 includes a display 22 that displays a graphical environment 30. The graphical environment 30 includes a rig 40. In some implementations, the graphical environment 30 is a graphical user interface (GUI) that allows the user 12 to create, modify and/or explore the rig 40. As such, the graphical environment 30 may be referred to as rig editing interface. In some implementations, the rig 40 is associated with a virtual object. For example, the rig 40 may represent a physical structure of the virtual object. In some implementations, the virtual object is a virtual character and the rig is a skeleton of the virtual character. As such, in some implementations, the rig 40 includes a set of interconnected joints (e.g., elbow joints, knee joints, shoulder joints, hip joint, etc.). In some implementations, the graphical environment 30 is an extended reality (XR) environment. In some implementations, the rig 40 is displayed as an augmented reality (AR) element that is overlaid onto a pass-through representation of the physical environment 10.

In various implementations, the electronic device 20 detects a gesture performed by the user 12. In response to detecting the gesture, the electronic device 20 obtains interaction data that characterizes an interaction of the user 12 in the physical environment 10. In some implementations, the rig manipulation system 200 utilizes a mapping 240 to map the gesture and the interaction to a particular rig manipulation, and the electronic device 20 manipulates the rig 40 in accordance with the particular rig manipulation. Since a number of gestures that the electronic device 20 may be trained to detect may be smaller than a number of manipulations that the rig 40 can perform, the mapping 240 allows the rig manipulation system 200 to select a particular rig manipulation for the rig 40 when there are multiple rig manipulations available for a gesture that the electronic device 20 detects. Persons skilled in the art will appreciate that the gestures discussed in the applications and figures are merely examples, and any suitable user gestures and/or behavior can be used by the system to determine the appropriate rig manipulation. Additionally, different interaction criterion can be mapped to different gestures depending on the application, context, or type of rig that the user is manipulating.

In the example of FIG. 1A, the mapping 240 includes a first gesture G1 (e.g., a button press on the electronic device 20) and a second gesture G2 (e.g., a clapping gesture that includes the user 12 clapping his/her hands together). As illustrated in FIG. 1A, the first gesture G1 can trigger one or more of ten rig manipulations (e.g., a first rig manipulation RM1, a second rig manipulation RM2, . . . , and a tenth rig manipulation RM10). Similarly, the second gesture G2 can trigger one or more of another ten rig manipulations (e.g., an eleventh rig manipulation RM11, a twelfth rig manipulation RM12, . . . , and a twentieth rig manipulation RM20).

As illustrated in FIG. 1A, the mapping 240 maps various gesture-interaction pairs to corresponding rig manipulations. While a gesture on its own may trigger various rig manipulations, a gesture paired with a specific interaction criterion triggers a particular one of the rig manipulations. In the example of FIG. 1A, the first gesture G1 along with a real-world interaction that satisfies a first interaction criterion IC1 triggers the first rig manipulation RM1. For example, when the user 12 presses a button on the electronic device 20 during the daytime, the rig manipulation system 200 moves the rig 40 to an up position. Similarly, the first gesture G1 along with a real-world interaction that satisfies a second interaction criterion IC2 triggers the second rig manipulation RM2. For example, when the user 12 presses the button on the electronic device 20 during nighttime, the rig manipulation system 200 moves the rig 40 to a down position. In some examples, the rig 40 may be a desk that can be moved between an up position (e.g., a standing position) and a down position (e.g., a sitting position). In such examples, pressing a button during the daytime triggers the desk to move to the up position so that the user 12 may stand while working, and pressing the same button during nighttime triggers the desk to move to the down position. The user 12 can specify the interaction criteria IC1 and IC2. For example, the user 12 can specify a first time duration for moving the rig 40 to the up position upon detecting the button press and a second time duration for moving the rig 40 to the down position upon detecting the same button being pressed.

Referring to FIG. 1B, the electronic device 20 detects the first gesture G1 being performed by the user 12. For example, the electronic device 20 detects a button press. In some examples, the electronic device 20 includes a physical button and detecting the first gesture G1 includes detecting that the user 12 has pressed the physical button. Alternatively, in some examples, the electronic device 20 presents a GUI that includes various GUI elements that operate as buttons and detecting the first gesture G1 includes detecting that the user 12 has pressed one of the GUI elements displayed as part of the GUI. The first gesture G1 corresponds to a request to manipulate the rig 40. However, as can be seen in the mapping 240, the first gesture G1 may correspond to a request to manipulate the rig 40 in accordance with any one of the ten rig manipulations RM1 . . . . RM10. In order to determine which of the ten rig manipulations RM1 . . . . RM10 is the most suitable rig manipulation or is the rig manipulation that the user 12 likely wants, the electronic device 20 obtains interaction data that characterizes an interaction of the user 12 in the physical environment 10 (e.g., a real-world interaction).

FIG. 1C illustrates a timeline 60 with an indication of a current time 62. In the example of FIG. 1C, the interaction data includes the current time 62. Additionally or alternatively, the interaction data may indicate a time at which the electronic device 20 detected the first gesture G1 (e.g., a time at which the user 12 pressed the button). In some implementations, the first interaction criterion IC1 specifies a time duration (e.g., from 6 am to 8 pm). The rig manipulation system 200 determines whether the interaction data satisfies the first interaction criterion IC1 by determining whether the current time 62 is within the time duration specified by the first interaction criterion IC1. Since the current time 62 is within the time duration specified by the first interaction criterion IC1, the rig manipulation system 200 determines that the first interaction criterion IC1 has been satisfied. As such, the rig manipulation system 200 performs the first rig manipulation RM1. For example, as shown in FIG. 1C, the rig manipulation system 200 moves the rig 40 to the up position. In some examples, the rig 40 represents a desk that can be moved between a standing position and a sitting position, and the rig manipulation system 200 moves the desk to the standing position in response to detecting the button press between 6 am and 8 pm.

Referring to FIG. 1D, the electronic device 20 may detect another button press. In the example of FIG. 1D, the button press occurs at a current time 64 that is after 8 pm. The rig manipulation system 200 determines that the button press satisfies the second interaction criterion IC2 since the button press occurred at nighttime. As such, the rig manipulation system 200 performs the second rig manipulation RM2 by moving the rig 40 from the up position to the down position. For example, if the rig 40 represents the desk that can be moved between the standing position and the sitting position, the rig manipulation system 200 moves the desk to the sitting position in response to detecting the button press after 8 pm. In the example of FIG. 1D, the rig 40 is initially in the up position. However, if the electronic device 20 detects a button press after 8 pm and the rig 40 is already in the down position, then the rig manipulation system 200 may not move the rig 40.

FIGS. 1E and 1F illustrate different rig manipulations based on a geographical location of the electronic device 20. In some implementations, the rig 40 can be manipulated between an open position and a closed position. For example, the rig 40 may be a box that can be opened to reveal contents of the box and closed to conceal the contents of the box. In some implementations, the third interaction criterion IC3 specifies that the rig 40 can be manipulated into the open position when the electronic device 20 is located at a private location (e.g., at a home of the user 12). In some implementations, the fourth interaction criterion IC4 specifies that the rig 40 can be manipulated into the closed position when the electronic device 20 is located at a public location (e.g., outside the home of the user 12). The user 12 can specify the private location by providing an address or by defining a geographical boundary.

FIG. 1E illustrates a geographical boundary 70. Locations within the geographical boundary 70 may be considered private locations and locations outside the geographical boundary 70 may be considered public locations. The geographical boundary 70 may correspond to a home of the user 12. The user 12 may have specified the geographical boundary 70 by providing his/her home address or by drawing the geographical boundary 70 on a map. As illustrated in FIG. 1E, a current location 72 of the electronic device 20 is within the geographical boundary 70. Since the current location 72 is inside the geographical boundary 70, the rig manipulation system 200 determines that the third interaction criterion IC3 is satisfied. As such, the rig manipulation system 200 performs the third rig manipulation RM3 by manipulating the rig 40 into the open position. For example, if the rig 40 includes a box that can be opened to reveal its contents, the rig manipulation system 200 manipulates the rig 40 into the open position to reveal its contents. As another example, the rig 40 may be manipulated between an expanded position and a contracted position and the rig manipulation system 200 may manipulate the rig 40 into the expanded position in response to detecting the first gesture G1 being performed at a private location.

Referring to FIG. 1F, the electronic device 20 detects the first gesture G1 when a current location 74 of the electronic device 20 is outside the geographical boundary 70. Since the current location 74 of the electronic device 20 is outside the geographical boundary 70, the rig manipulation system 200 may determine that the first gesture G1 is being performed at a public location as specified by the fourth interaction criterion IC4. In response to determining that the first gesture G1 and the current location 74 of the electronic device 20 have satisfied the fourth interaction criterion IC4, the rig manipulation system 200 performs the fourth rig manipulation RM4. For example, if the rig 40 includes a box that can be closed to conceal its contents, the rig manipulation system 200 manipulates the rig 40 into the close position to conceal its contents. As another example, the rig 40 may be manipulated between an expanded position and a contracted position and the rig manipulation system 200 may manipulate the rig 40 into the contracted position in response to detecting the first gesture G1 being performed at a public location.

Referring to FIGS. 1G and 1H, in some implementations, the rig manipulation system 200 obtains interaction data that indicates a number of people that are in the physical environment 10. In some implementations, the rig manipulation system 200 performs different manipulations on the rig 40 based on the number of people that are in the physical environment 10. In some implementations, the number of people represents a number of bystanders. In some implementations, the number of people represents a number of people that are interacting with the rig 40 (e.g., viewing the rig 40 and/or manipulating the rig 40). The rig manipulation system 200 may perform different manipulations on the rig 40 based on the number of people in response to detecting the first gesture G1 being performed.

In the example of FIG. 1G, a first number of people 80 is one since the physical environment 10 does not include persons other than the user 12. The rig manipulation system 200 may determine that the first number of people 80 satisfies the fifth interaction criterion IC5. In response to determining that the interaction data satisfies the fifth interaction criterion IC5, the rig manipulation system 200 manipulates the rig 40 in accordance with the fifth rig manipulation RM5. In some implementations, the fifth rig manipulation RM5 places the rig 40 in a focused mode where the rig 40 is closer to the user 12 and a front portion (e.g., a front face) of the rig 40 is facing the user 12. As illustrated in FIG. 1G, performing the fifth rig manipulation RM5 may include rotating and translating the rig 40.

Referring to FIG. 1H, the physical environment 10 includes a person 14 in addition to the user 12. As such, a second number of people 82 in the physical environment 10 is two. The rig manipulation system 200 may determine that the second number of people 82 satisfies a sixth interaction criterion IC6 and manipulate the rig 40 in accordance with a sixth rig manipulation RM6. In some implementations, the sixth rig manipulation RM6 places the rig 60 in a collaborative mode where the rig 40 is equidistant from the user 12 and the person 14. Performing the sixth rig manipulation RM6 may allow both the user 12 and the person 14 to view and/or manipulate the rig 40 in a convenient manner.

Referring to FIGS. 1I and 1J, in some implementations, the same gesture triggers the rig manipulation system 200 to perform different manipulations on the rig 40 based on a characteristic of the physical environment 10. In some implementations, the characteristic indicates an environmental characteristic such as a temperature value, a humidity value, etc. In some implementations, the characteristic indicates a sensory characteristic such as an ambient lighting level or an ambient sound level of the physical environment 10. In some implementations, the characteristic indicates a physical property of the physical environment 10 such as a roughness or a smoothness of a floor of the physical environment 10. In the example of FIGS. 1I and 1J, a seventh interaction criterion IC7 is satisfied when a floor of the physical environment 10 is rough (e.g., carpeted) and an eighth interaction criterion IC8 is satisfied when the floor of the physical environment 10 is smooth (e.g., covered with ceramic tiles).

Referring to FIG. 1I, the rig manipulation system 200 obtains interaction data that indicates a first characteristic 90 of the physical environment 10. For example, the first characteristic 90 may indicate that the floor of the physical environment 10 has a roughness that is greater than a roughness threshold. As an example, the first characteristic 90 may indicate that the floor of the physical environment 10 is carpeted. In the example of FIG. 1I, the rig manipulation system 200 determines that the first characteristic 90 satisfies the seventh interaction criterion IC7. In response to determining that the first characteristic 90 satisfies the seventh interaction criterion IC7, the rig manipulation system 200 performs a seventh manipulation RM7 on the rig 40. For example, the rig manipulation system 200 displays a relatively slow movement of the rig 40.

Referring to FIG. 1J, the rig manipulation system 200 obtains interaction data that indicates a second characteristic 92 of the physical environment 10. For example, the second characteristic 92 may indicate that the floor of the physical environment 10 has a smoothness that is greater than a smoothness threshold. As an example, the second characteristic 92 may indicate that the floor of the physical environment 10 is covered with ceramic tiles. In the example of FIG. 1J, the rig manipulation system 200 determines that the second characteristic 92 satisfies the eighth interaction criterion IC8. In response to determining that the second characteristic 92 satisfies the eighth interaction criterion IC8, the rig manipulation system 200 performs an eighth manipulation RM8 on the rig 40. For example, the rig manipulation system 200 displays a relatively fast movement of the rig 40 as indicated by three dashes on the right side of the rig 40 and the relatively long arrow corresponding to the eighth rig manipulation RM8.

Referring to FIGS. 1K and 1L, in some implementations, the same gesture triggers the rig manipulation system 200 to perform different manipulations on the rig 40 based on a speech characteristic of a speech 100 of the user 12. In some implementations, the speech characteristic is an amplitude of the speech 100. For example, the same gesture may trigger the rig manipulation system 200 to perform different manipulations based on different amplitudes of the speech 100. In some implementations, the speech characteristic is a frequency of the speech 100 (e.g., a pitch of the speech 100). For example, the same gesture may trigger the rig manipulation system 200 to perform different manipulations for low pitch and high pitch speech of the user 12. In the example of FIGS. 1K and 1L, a ninth interaction criterion IC9 is satisfied when an amplitude of the speech 100 is greater than a first amplitude threshold and a tenth interaction criterion IC10 is satisfied when the amplitude of the speech 100 is less than a second amplitude threshold. For example, as shown in FIG. 1K, the rig manipulation system 200 performs the ninth rig manipulation RM9 when the speech 100 has a first speech characteristic 102 (e.g., the speech 100 includes relatively loud speech). Performing the ninth rig manipulation RM9 may include moving the rig abruptly, for example, by moving the rig 40 at variable speeds as indicated by the two differently sized arrows corresponding to the ninth rig manipulation RM9. By contrast, as shown in FIG. 1L, the rig manipulation system 200 performs the tenth rig manipulation RM10 when the speech 100 has a second speech characteristic 104 (e.g., the speech 100 includes relatively soft speech). Performing the tenth rig manipulation RM10 may include moving the rig smoothly, for example, by moving the rig 40 at a constant speed as indicated by the two equally sized arrows corresponding to the tenth rig manipulation RM10.

Referring to FIGS. 1M and 1N, the electronic device 20 detects a second gesture G2. The second gesture G2 may include the user 12 clapping his/her hands. The clapping gesture may correspond to a general request to move the rig 40. However, the rig manipulation system 200 obtains interaction data that indicates an interaction of the user 12 in the physical environment 10 in order to determine a specific movement for the rig 40. In the example of FIGS. 1M and 1N, the second gesture G2 triggers the rig manipulation system 200 to perform different manipulations on the rig 40 based on a gaze of the user 12. In the example of FIGS. 1M and 1N, an eleventh interaction criterion IC11 is satisfied when the user 12 is gazing at the rig 40 and a twelfth interaction criterion IC12 is satisfied when the user 12 is gazing away from the rig 40. As shown in FIG. 1M, the rig manipulation system 200 performs the eleventh rig manipulation RM11 when a first gaze vector 112 indicates that the user is gazing at the rig 40. For example, clapping his/her hands while gazing at the rig 40 causes the rig manipulation system 200 to move the rig 40 towards the user 12. As shown in FIG. 1N, the rig manipulation system 200 performs the twelfth rig manipulation RM 12 when a second gaze vector 114 indicates that the user 12 is gazing away from the rig 40 (e.g., when the user 12 is not looking at the rig 40). For example, clapping his/her hands while not gazing at the rig 40 causes the rig manipulation system 200 to move the rig 40 away from the user 12. In some examples, the user 12 summons the rig 40 by clapping while looking at the rig 40, and the user 12 makes the rig 40 go away by clapping while not looking at the rig 40.

Referring to FIGS. 10 and 1P, in some implementations, the same gesture triggers the rig manipulation system 200 to perform different manipulations on the rig 40 based on a facial expression of the user 12. In the example of FIGS. 1O and 1P, a thirteenth interaction criterion IC13 is satisfied when the user 12 has a first type of facial expression (e.g., a neutral facial expression) and a fourteenth interaction criterion IC14 is satisfied when the user 12 has a second type of facial expression (e.g., an excited facial expression). As shown in FIG. 1O, the rig manipulation system 200 performs an thirteenth rig manipulation RM13 when a first facial expression 116 indicates that the user 12 has the first type of facial expression. For example, clapping his/her hands with a neutral facial expression causes the rig manipulation system 200 to move the rig 40 towards the user 12 along a floor of the graphical environment 30. As shown in FIG. 1P, the rig manipulation system 200 performs a fourteenth rig manipulation RM 14 when a second facial expression 118 indicates that the user 12 has the second type of facial expression. For example, clapping his/her hands while being excited causes the rig manipulation system 200 to move the rig 40 towards the user 12 by getting airborne. In some implementations, the rig 40 represents a virtual dog that walks towards the user 12 when the user 12 claps his/her hands with a neutral facial expression and the virtual dog leaps towards the user 12 when the user 12 claps his/her hands while smiling.

Referring to FIGS. 1Q and 1R, in some implementations, the same gesture triggers the rig manipulation system 200 to perform different manipulations on the rig 40 based on a body pose of the user 12. In the example of FIGS. 1Q and 1R, a fifteenth interaction criterion IC15 is satisfied when the user 12 has a first type of body pose (e.g., a neutral body pose) and a sixteenth interaction criterion IC16 is satisfied when the user 12 has a second type of body pose (e.g., a tense body pose). As shown in FIG. 1Q, the rig manipulation system 200 performs a fifteenth rig manipulation RM15 when a first body pose 120 indicates that the user 12 has the first type of body pose. For example, clapping his/her hands with a neutral body pose causes the rig 40 to finish a current move before moving towards the user 12. In the example of FIG. 1Q, the rig 40 continues to a current destination and goes to a next destination after reaching the current destination. As shown in FIG. 1R, the rig manipulation system 200 performs a sixteenth rig manipulation RM16 when a second body pose 122 indicates that the user 12 has the second type of body pose. For example, clapping his/her hands with a tense body pose causes the rig 40 to abandon the current destination and move to the next destination.

Referring to FIGS. 1S and 1T, in some implementations, the same gesture triggers the rig manipulation system 200 to perform different manipulations on the rig 40 based on a physiological measurement of the user 12. Examples of the physiological measurement include a heart rate value, a blood glucose value, etc. In the example of FIGS. 1S and 1T, a seventeenth interaction criterion IC17 is satisfied when the physiological measurement is within a first range of values (e.g., a normal value range) and an eighteenth interaction criterion IC18 is satisfied when the physiological measurement is within a second range of values (e.g., an abnormal value range, for example, an elevated value range or a deflated value range). As shown in FIG. 1S, the rig manipulation system 200 performs a seventeenth rig manipulation RM17 when a first physiological measurement value 124 is within the first range of values. For example, clapping his/her hands while having a normal heart rate causes the rig 40 to move towards the user 12 at a normal speed. As shown in FIG. 1T, the rig manipulation system 200 performs an eighteenth rig manipulation RM18 when a second physiological measurement value 126 is within the second range of values. For example, clapping his/her hands while having an elevated heart rate causes the rig 40 to move towards the user 12 at an elevated speed.

Referring to FIGS. 1U and 1V, in some implementations, the same gesture triggers the rig manipulation system 200 to perform different manipulations on the rig 40 based on a grip of the user 12. The grip may indicate how tightly the user 12 is holding the electronic device 20. In the example of FIGS. 1U and 1V, a nineteenth interaction criterion IC19 is satisfied when the grip is of a first type (e.g., a tight grip on the electronic device 20) and a twentieth interaction criterion IC20 is satisfied when the grip is of a second type (e.g., a loose grip on the electronic device 20 or not holding the electronic device 20 at all). As shown in FIG. 1U, the rig manipulation system 200 performs a nineteenth rig manipulation RM19 when a first grip 130 matches the first type of grip. For example, clapping his/her hands while holding the electronic device 20 tightly causes the rig 40 to move towards the user 12 in a rigid manner (e.g., along a straight path). As shown in FIG. 1V, the rig manipulation system 200 performs a twentieth rig manipulation RM20 when a second grip 132 matches the second type of grip. For example, clapping his/her hands while holding the electronic device 20 loosely or not holding the electronic device 20 causes the rig 40 to move towards the user 12 in a flexible manner (e.g., along a wavy path). While FIGS. 1U and 1V illustrate two types of grips, additional grip types are also contemplated. For example, in some implementations, the rig manipulation system 200 is configured to detect an n-number of grip types and perform a different rig manipulation in response to detecting each of the n-number of grip types.

In some implementations, the user 12 concurrently exhibits multiple types of grips. For example, the user 12 simultaneously exhibits a first type of grip by gripping a first rig control with a thumb and an index finger and a second type of grip by gripping a second rig control with a middle finger, a ring finger, a pinky finger and a palm of a hand. In this example, the rig manipulation system 200 simultaneously detects two different types of grips. In some implementations, the mapping 240 maps a simultaneous occurrence of the two different types of grips to a particular rig manipulation, and the rig manipulation system 200 performs that particular rig manipulation. Alternatively, in some implementations, the mapping 240 maps each type of grip to a separate rig manipulation and the rig manipulation system 200 performs two rig manipulations in a sequential manner.

In some implementations, the rig manipulation device 200 detects a type of grip of the user 12 while the user 12 is interacting with another hardware control device such as a mouse, a touchpad or a stylus. In some implementations, the rig manipulation device 200 detects a grip of a virtual representation of the user 12. For example, the rig manipulation device 200 detects a type of grip that an avatar of the user 12 exhibits. The user 12 may control the avatar by making gestures or by providing voice commands. For example, the user 12 may say “grab the left foot with hand3 and grab the right foot with hand4”. In this example, grabbing the left foot with hand3 and grabbing the right foot with hand4 may satisfy a particular interaction criterion that triggers a corresponding rig manipulation.

FIG. 2 is a block diagram of the rig manipulation system 200 in accordance with some implementations. In various implementations, the rig manipulation system 200 includes a gesture detector 210, an interaction data obtainer 220, a rig manipulator 230 and the mapping 240. In various implementations, the mapping 240 maps a set of predefined gestures 242 and interaction criteria 244 to corresponding rig manipulations 246. As illustrated in FIGS. 1A-IV, due to the limited availability of gestures and/or the numerosity of rig manipulations, the same predefined gesture 242 may trigger multiple rig manipulations 246. However, when the predefined gesture 242 is paired with a particular one of the interaction criteria 244, the pairing triggers a particular one of the rig manipulations 246.

In various implementations, the gesture detector 210 detects a gesture 212 being performed by a user of a device. In some implementations, detecting the gesture 212 includes detecting a user input via an input device such as a button, a touchscreen, a control device, etc. For example, the gesture detector 210 detects the first gesture G1 (shown in FIG. 1B). In some implementations, detecting the gesture 212 includes detecting an audio input via a microphone. For example, the gesture detector 210 detects the second gesture G2 (shown in FIG. 1M). The gesture detector 210 provides the gesture 212 to the rig manipulator 230.

In various implementations, the interaction data obtainer 220 obtains interaction data 222 that characterizes an interaction of the user in a physical environment (e.g., a real-world interaction). For example, the interaction data 222 characterizes the interaction of the user 12 in the physical environment 10 shown in FIGS. 1A-1V. In some implementations, the interaction data 222 indicates a current time 222a (e.g., the current time 62 shown in FIG. 1C and/or the current time 64 shown in FIG. 1D). In some implementations, the current time 222a corresponds to a time at which the gesture detector 210 detected the gesture 212. In some implementations, the interaction data 222 indicates a current location 222b of the device (e.g., the current location 72 shown in FIG. 1E and/or the current location 74 shown in FIG. 1F). In some implementations, the current location 222b corresponds to a location of the device when the gesture detector 210 detected the gesture 212.

In some implementations, the interaction data 222 indicates a number of people 222c that are within a proximity threshold of the device (e.g., the first number of people 80 shown in FIG. 1G and/or the second number of people 82 shown in FIG. 1H). In some implementations, the number of people 222c refers to people that may be viewing and/or interacting with the rig. In some implementations, the interaction data 222 indicates a characteristic 222d of the physical environment where the gesture detector 210 detected the gesture 212 (e.g., the first characteristic 90 shown in FIG. 1I and/or the second characteristic 92 shown in FIG. 1J).

In some implementations, the interaction data 222 indicates a speech characteristic 222c of a speech of the user (e.g., the first speech characteristic 102 shown in FIG. 1K and/or the second speech characteristic shown in FIG. 1L). For example, the speech characteristic 222c may indicate whether the user was speaking loudly or softly while making the gesture 212. As another example, the speech characteristic 222e may indicate whether or not the user was talking about the rig while making the gesture 212.

In some implementations, the interaction data 222 includes a gaze vector 222f (e.g., the first gaze vector 112 shown in FIG. 1M and/or the second gaze vector 114 shown in FIG. 1N). In some implementations, the gaze vector 222f indicates a gaze direction, a gaze intensity and/or a gaze duration of the user while making the gesture 212. For example, the gaze vector 222f indicates whether or not the user was looking at the rig while making the gesture 212.

In some implementations, the interaction data 222 indicates a facial expression 222g of the user when the user made the gesture 212 (e.g., the first facial expression 116 shown in FIG. 1O and/or the second facial expression 118 shown in FIG. 1P). In some implementations, the interaction data obtainer 220 obtains a facial image of the user and determines the facial expression of the user based on the facial image.

In some implementations, the interaction data 222 indicates a body pose 222h of the user when the user made the gesture 212 (e.g., the first body pose 120 shown in FIG. 1Q and/or the second body pose 122 shown in FIG. 1R). In some implementations, the interaction data obtainer 220 obtains an image depicting the user and determines the body pose of the user based on the image.

In some implementations, the interaction data 222 includes a physiological measurement 222i of the user when the user made the gesture 212 (e.g., the first physiological measurement value 124 shown in FIG. 1S and/or the second physiological measurement value 126 shown in FIG. 1T). In some implementations, the physiological measurement 222i includes a heart rate value, a blood glucose measurement, or the like.

In some implementations, the interaction data 222 indicates a type of grip 222j of the user when the user made the gesture 212 (e.g., the first grip 130 shown in FIG. 1U and/or the second grip 132 shown in FIG. 1V). In some implementations, the type of grip 222j indicates whether the user is holding the device tightly or loosely. The interaction data obtainer 220 may receive data from a pressure sensor and determine the type of grip 222j based on the data received from the pressure sensor. In some implementations, the type of grip 222j indicates a hand pose of a hand of the user (e.g., whether the hand is open or closed). The interaction data obtainer 220 may receive an image of the hand and determine the type of grip 222j based on the image of the hand.

In various implementations, the rig manipulator 230 manipulates the rig in accordance with one of the rig manipulations 246 based on the gesture 212 and the interaction data 222. In some implementations, the rig manipulator 230 matches the gesture 212 to one of the predefined gestures 242. Since each of the predefined gestures 242 may trigger multiple ones of the rig manipulations 246, the rig manipulator 230 further determines whether the interaction data 222 satisfies one of the interaction criteria 244. If the interaction data 222 satisfies one of the interaction criteria 244, the rig manipulator 230 selects the rig manipulation 246 that the gesture 212 and the satisfied interaction criteria 244 map to as a selected rig manipulation 232. The rig manipulator 230 manipulates the rig in accordance with the selected rig manipulation 232.

In some implementations, one of the interaction criteria 244 includes a temporal criterion (e.g., the first interaction criterion IC1 described in relation to FIG. 1C or the second interaction criterion IC2 described in relation to FIG. 1D). In some implementations, the rig manipulator 230 determines that the temporal criterion is satisfied when the current time 222a indicated by the interaction data 222 (e.g., a time at which the gesture 212 was detected) is within a time period specified by the temporal criterion. If the rig manipulator 230 determines that the temporal criterion is satisfied, the rig manipulator 230 selects the rig manipulation 246 associated with the temporal criterion as the selected rig manipulation 232 (e.g., the first rig manipulation RM1 described in relation to FIG. 1C or the second rig manipulation RM2 described in relation to FIG. 1D).

In some implementations, one of the interaction criteria 244 includes a geographical criterion (e.g., the third interaction criterion IC3 described in relation to FIG. 1E or the fourth interaction criterion IC4 described in relation to FIG. 1F). In some implementations, the rig manipulator 230 determines that the geographical criterion is satisfied when the current location 222b indicated by the interaction data 222 (e.g., a location where the gesture 212 was detected) is within a geographical region specified by the geographical criterion. If the rig manipulator 230 determines that the geographical criterion is satisfied, the rig manipulator 230 selects the rig manipulation 246 associated with the geographical criterion as the selected rig manipulation 232 (e.g., the third rig manipulation RM3 described in relation to FIG. 1E or the fourth rig manipulation RM4 described in relation to FIG. 1F).

In some implementations, one of the interaction criteria 244 includes a personnel criterion (e.g., the fifth interaction criterion IC5 described in relation to FIG. 1G or the sixth interaction criterion IC6 described in relation to FIG. 1H). In some implementations, the rig manipulator 230 determines that the personnel criterion is satisfied when the number of people 222c indicated by the interaction data 222 (e.g., a number of people near the device when the gesture 212 is detected) is within a numerical range specified by the personnel criterion. If the rig manipulator 230 determines that the personnel criterion is satisfied, the rig manipulator 230 selects the rig manipulation 246 associated with the personnel criterion as the selected rig manipulation 232 (e.g., the fifth rig manipulation RM5 described in relation to FIG. 1G or the sixth rig manipulation RM6 described in relation to FIG. 1H).

In some implementations, one of the interaction criteria 244 includes an environmental criterion (e.g., the seventh interaction criterion IC7 described in relation to FIG. 1I or the eighth interaction criterion IC8 described in relation to FIG. 1J). In some implementations, the rig manipulator 230 determines that the environmental criterion is satisfied when the characteristic 222d indicated by the interaction data 222 (e.g., a characteristic of the physical environment where the gesture 212 was detected) matches a threshold characteristic specified by the environmental criterion. If the rig manipulator 230 determines that the environmental criterion is satisfied, the rig manipulator 230 selects the rig manipulation 246 associated with the environmental criterion as the selected rig manipulation 232 (e.g., the seventh rig manipulation RM7 described in relation to FIG. 1I or the eighth rig manipulation RM8 described in relation to FIG. 1J).

In some implementations, one of the interaction criteria 244 includes an audible signal data criterion (e.g., the ninth interaction criterion IC9 described in relation to FIG. 1K or the tenth interaction criterion IC10 described in relation to FIG. 1L). In some implementations, the rig manipulator 230 determines that the audible signal data criterion is satisfied when the speech characteristic 222e indicated by the interaction data 222 (e.g., a speech characteristic of the user or an ambient sound characteristic) matches a threshold audible data characteristic specified by the audible signal data criterion. If the rig manipulator 230 determines that the audible signal data criterion is satisfied, the rig manipulator 230 selects the rig manipulation 246 associated with the audible signal data criterion as the selected rig manipulation 232 (e.g., the ninth rig manipulation RM9 described in relation to FIG. 1K or the tenth rig manipulation RM10 described in relation to FIG. 1L).

In some implementations, one of the interaction criteria 244 includes a gaze criterion (e.g., the eleventh interaction criterion IC11 described in relation to FIG. 1M or the twelfth interaction criterion IC12 described in relation to FIG. 1N). In some implementations, the rig manipulator 230 determines that the gaze criterion is satisfied when a gaze direction, a gaze intensity and/or a gaze duration indicated by the gaze vector 222f matches a threshold gaze direction, a threshold gaze intensity and/or a threshold gaze duration specified by the gaze criterion. If the rig manipulator 230 determines that the gaze criterion is satisfied, the rig manipulator 230 selects the rig manipulation 246 associated with the gaze criterion as the selected rig manipulation 232 (e.g., the eleventh rig manipulation RM11 described in relation to FIG. 1M or the twelfth rig manipulation RM12 described in relation to FIG. 1N).

In some implementations, one of the interaction criteria 244 includes a facial expression criterion (e.g., the thirteenth interaction criterion IC11 described in relation to FIG. 1O or the fourteenth interaction criterion IC14 described in relation to FIG. 1P). In some implementations, the rig manipulator 230 determines that the facial expression criterion is satisfied when the facial expression 222g indicated by the interaction data 222 matches a particular facial expression specified by the facial expression criterion. If the rig manipulator 230 determines that the facial expression criterion is satisfied, the rig manipulator 230 selects the rig manipulation 246 associated with the facial expression criterion as the selected rig manipulation 232 (e.g., the thirteenth rig manipulation RM13 described in relation to FIG. 1O or the fourteenth rig manipulation RM14 described in relation to FIG. 1P).

In some implementations, one of the interaction criteria 244 includes a body pose criterion (e.g., the fifteenth interaction criterion IC15 described in relation to FIG. 1Q or the sixteenth interaction criterion IC14 described in relation to FIG. 1R). In some implementations, the rig manipulator 230 determines that the body pose criterion is satisfied when the body pose 222h indicated by the interaction data 222 matches a type of body pose specified by the body pose criterion. If the rig manipulator 230 determines that the body pose criterion is satisfied, the rig manipulator 230 selects the rig manipulation 246 associated with the body pose criterion as the selected rig manipulation 232 (e.g., the fifteenth rig manipulation RM15 described in relation to FIG. 1Q or the sixteenth rig manipulation RM14 described in relation to FIG. 1R).

In some implementations, one of the interaction criteria 244 includes a physiological criterion (e.g., the seventeenth interaction criterion IC17 described in relation to FIG. 1S or the eighteenth interaction criterion IC18 described in relation to FIG. 1T). In some implementations, the rig manipulator 230 determines that the physiological criterion is satisfied when the physiological measurement 222i indicated by the interaction data 222 is within a range of values specified by the physiological criterion. If the rig manipulator 230 determines that the physiological criterion is satisfied, the rig manipulator 230 selects the rig manipulation 246 associated with the physiological criterion as the selected rig manipulation 232 (e.g., the seventeenth rig manipulation RM17 described in relation to FIG. 1S or the eighteenth rig manipulation RM18 described in relation to FIG. 1T).

In some implementations, one of the interaction criteria 244 includes a grip criterion (e.g., the nineteenth interaction criterion IC19 described in relation to FIG. 1U or the twentieth interaction criterion IC20 described in relation to FIG. 1V). In some implementations, the rig manipulator 230 determines that the grip criterion is satisfied when the type of grip 222j indicated by the interaction data 222 matches a grip type specified by the grip criterion. If the rig manipulator 230 determines that the grip criterion is satisfied, the rig manipulator 230 selects the rig manipulation 246 associated with the grip criterion as the selected rig manipulation 232 (e.g., the nineteenth rig manipulation RM19 described in relation to FIG. 1U or the twentieth rig manipulation RM20 described in relation to FIG. 1V).

FIG. 3 is a flowchart representation of a method 300 for manipulating a rig in different manners according to a gesture and a real-world interaction indicated by interaction data obtained via one or more sensors. In various implementations, the method 300 is performed by the electronic device 20 shown in FIGS. 1A-1V and/or the rig manipulation system 200 shown in FIGS. 1A-2. In some implementations, the method 300 is performed by processing logic, including hardware, firmware, software, or a combination thereof. In some implementations, the method 300 is performed by a processor executing code stored in a non-transitory computer-readable medium (e.g., a memory).

As represented by block 310, in various implementations, the method 300 includes, while displaying a rig on the display, detecting a gesture that corresponds to a request to manipulate the rig. For example, as shown in FIG. 1B, the electronic device 20 detects the first gesture G1 that corresponds to a request to manipulate the rig 40. In some implementations, detecting the gesture includes detecting a user input provided via an input device such as a touchscreen, a button on the device or a control device that is coupled with the device. For example, as described in relation to FIG. 1B, the first gesture G1 may include a button press. In some implementations, detecting the gesture includes detecting a three-dimensional (3D) gesture performed by the user of the device. In some implementations, detecting the gesture includes obtaining a sequence of images that depicts the user, performing instance segmentation on the image to identify hands of the user and performing semantic segmentation on the image to identify a gesture being made by the hands.

As represented by block 310a, in some implementations, the rig is associated with a virtual character. In some implementations, the rig includes a set of interconnected joints that collectively form a skeleton of the virtual character. In some implementations, applying respective torque values to the joints causes the joints to rotate thereby triggering a movement of the rig. In some implementations, the rig is associated with a representation of a virtual agent. For example, the rig represents a structural frame of an avatar of the virtual agent.

As represented by block 320, in various implementations, the method 300 includes, in response to detecting the gesture, obtaining, via the one or more sensors, interaction data that characterizes an interaction of a user of the electronic device in a physical environment of the electronic device (e.g., a real-world interaction of the user). For example, as shown in FIG. 2, the interaction data obtainer 220 obtains the interaction data 222 after the gesture detector 210 detects the gesture 212. As represented by block 320a, in some implementations, the interaction includes a current interaction (e.g., a current behavior of the user). Alternatively, in some implementations, the interaction includes a historical interaction (e.g., a past behavior of the user).

In some implementations, obtaining the interaction data includes capturing sensor data via one or more of the sensors and determining the interaction data based on the sensor data. For example, in some implementations, obtaining the interaction data includes obtaining a current time from a clock sensor (e.g., the current time 222a shown in FIG. 2). In some implementations, obtaining the interaction data includes obtaining a current location from a location sensor (e.g., the current location 222b shown in FIG. 2). In some implementations, obtaining the interaction data includes obtaining image data from an image sensor and determining a number of people within a threshold distance of the device (e.g., the number of people 222c shown in FIG. 2). In some implementations, obtaining the interaction data includes obtaining image data from an image sensor and determining a characteristic of the physical environment based on the image data (e.g., the characteristic 222d shown in FIG. 2). In some implementations, obtaining the interaction data includes obtaining audible signal data via a microphone and determining an acoustic characteristic of sounds generated in the physical environment (e.g., determining a speech characteristic of speech being uttered in the physical environment, for example, the speech characteristic 222e shown in FIG. 2).

In some implementations, obtaining the interaction data includes obtaining image data that depicts an eye of the user (e.g., a retinal image) and determining a gaze vector that indicates a gaze direction, a gaze intensity and/or a gaze duration of a gaze of the user (e.g., the gaze vector 222f shown in FIG. 2). In some implementations, obtaining the interaction data includes obtaining image data that depicts a face of the user (e.g., a facial image) and determining a facial expression of the user based on the image data (e.g., the facial expression 222g shown in FIG. 2). In some implementations, obtaining the interaction data includes obtaining image data that depicts a body part of the user (e.g., an entire body of the user) and determining a body pose of the user based on the image data (e.g., the body pose 222h shown in FIG. 2). In some implementations, obtaining the interaction data includes obtaining physiological measurements from a sensor that measures a physiological characteristic such as a heart rate, a blood glucose measurement or the like. In some implementations, obtaining the interaction data includes obtaining pressure data from a pressure sensor and determining a type of grip of the user based on the pressure data (e.g., the type of grip 222j shown in FIG. 2).

As represented by block 330, in various implementations, the method 300 includes manipulating the rig in accordance with a first manipulation when the interaction data satisfies a first interaction criterion, and manipulating the rig in accordance with a second manipulation when the interaction data satisfies a second interaction criterion. Manipulating the rig in different manners based on different real-world interactions allows the device to detect a limited set of gestures since each gesture-interaction pair triggers a different rig manipulation. Utilizing real-world interactions along with a gesture to select a rig manipulation from various possible rig manipulations avoids the need for a dedicated gesture for each possible rig manipulation. Avoiding a dedicated gesture for each possible rig manipulation reduces the need to train the device to detect as many gestures as the number of possible rig manipulations thereby conserving resources associated with training the device to detect gestures. Limiting the number of gestures that the device can detect tends to improve a user experience of the device by reducing the need for the user to learn numerous gestures.

As represented by block 330a, in some implementations, the electronic device manipulates the rig in accordance with the first manipulation when a time at which the gesture is performed is within a first time period specified by the first interaction criterion, and the electronic device manipulates the rig in accordance with the second manipulation when the time at which the gesture is performed is within a second time period specified by the second interaction criterion. For example, as described in relation to FIGS. 1C and 1D, the rig manipulation system 200 performs the first rig manipulation RM1 when the current time 62 is within the first time duration specified by the first interaction criterion IC1, and rig manipulation system 200 performs the second rig manipulation RM2 when the current time 64 is within the second time duration specified by the second interaction criterion IC2.

In some implementations, the electronic device manipulates the rig in accordance with the first manipulation when a geographical location where the gesture is performed is a first type of geographical location specified by the first interaction criterion, and the electronic device manipulates the rig in accordance with the second manipulation when the geographical location where the gesture is performed is a second type of geographical location specified by the second interaction criterion. For example, as described in relation to FIGS. 1E and 1F, the rig manipulation system 200 performs the third rig manipulation RM3 when the first gesture G1 is performed within the geographical boundary 70, and the rig manipulation system 200 performs the fourth rig manipulation RM4 when the first gesture G1 is performed outside the geographical boundary 70. As another example, when the gesture is performed in a public location the device body-locks the rig so that the rig stays within a threshold distance of the user in the public location, and when the gesture is performed in a private location the device world-locks the rig so that the rig is displayed at the same location relative to another object in the private location. Body-locking the rig causes the device to display the rig at a fixed distance from the user regardless of the user's movement in the physical environment. World-locking the rig causes the device to display the rig at a fixed distance from a physical object in the physical environment.

As represented by block 330b, in some implementations, the electronic device manipulates the rig in accordance with the first manipulation when a number of people performing the gesture is one, and the electronic device manipulates the rig in accordance with the second manipulation when the number of people performing the gesture is more than one. For example, as described in relation to FIGS. 1G and 1H, the rig manipulation system 200 performs the fifth rig manipulation RM5 in response to the first number of people 80 being within a threshold distance of the electronic device 20, and the rig manipulation system 200 performs the sixth rig manipulation RM6 in response to the second number of people 82 being within the threshold distance of the electronic device 20.

As represented by block 330c, in some implementations, the interaction data indicates a material characteristic of the physical environment (e.g., the first characteristic 90 shown in FIG. 1I, the second characteristic 92 shown in FIG. 1J or the characteristic 222d shown in FIG. 2). In such implementations, the electronic device manipulates the rig in accordance with the first manipulation when the material characteristic matches a first material specified by the first interaction criterion, and the electronic device manipulates the rig in accordance with the second manipulation when the material characteristic matches a second material specified by the second interaction criterion. For example, as described in relation to FIGS. 11 and 1J, the rig manipulation system 200 performs the seventh rig manipulation RM7 when the physical environment 10 has a rough floor, and the rig manipulation system 200 performs the eighth rig manipulation RM8 when the physical environment 10 has a smooth floor.

As represented by block 330d, in some implementations, the interaction comprises an utterance (e.g., speech being spoken by a user of the electronic device). In such implementations, the electronic device manipulates the rig in accordance with the first manipulation when the utterance is associated with a first verbal characteristic specified by the first interaction criterion, and the electronic device manipulates the rig in accordance with the second manipulation when the utterance is associated with a second verbal characteristic specified by the second interaction criterion. For example, as described in relation to FIGS. 1K and 1L, the rig manipulation system 200 performs the ninth rig manipulation RM9 when the user 12 is speaking loudly, and the rig manipulation system 200 performs the tenth rig manipulation RM10 when the user is speaking softly (e.g., when the user is whispering).

In some implementations, the interaction data includes a gaze vector that characterizes a gaze of a user of the electronic device (e.g., the first gaze vector 112 shown in FIG. 1M, the second gaze vector 114 shown in FIG. 1N or the gaze vector 222f shown in FIG. 2). In such implementations, the electronic device manipulates the rig in accordance with the first manipulation when the gaze vector is associated with a first gaze characteristic, and the electronic device manipulates the rig in accordance with the second manipulation when the gaze vector is associated with a second gaze characteristic that is different from the first gaze characteristic. For example, as described in relation to FIGS. 1M and 1N, the rig manipulation system 200 performs the eleventh rig manipulation RM 11 when the user 12 is gazing at the rig 40, and the rig manipulation system 200 performs the twelfth rig manipulation RM12 when the user 12 is not gazing at the rig 40.

In some implementations, the interaction data indicates a facial expression of a user of the electronic device (e.g., the first facial expression 116 shown in FIG. 1O, the second facial expression 118 shown in FIG. 1P or the facial expression 222g shown in FIG. 2). In such implementations, the electronic device manipulates the rig in accordance with the first manipulation when the facial expression matches a first type of facial expression specified by the first interaction criterion, and the electronic device manipulates the rig in accordance with the second manipulation when the facial expression matches a second type of facial expression specified by the second interaction criterion. For example, as described in relation to FIGS. 10 and 1P, the rig manipulation system 200 performs the thirteenth rig manipulation RM 13 when the user 12 has a neutral facial expression, and the rig manipulation system 200 performs the fourteenth rig manipulation RM14 when the user 12 has an excited facial expression.

In some implementations, the interaction data indicates a body pose of a user of the electronic device (e.g., the first body pose 120 shown in FIG. 1Q, the second body pose 122 shown in FIG. 1R or the body pose 222h shown in FIG. 2). In such implementations, the electronic device manipulates the rig in accordance with the first manipulation when the body pose matches a first body pose specified by the first interaction criterion, and the electronic device manipulates the rig in accordance with the second manipulation when the body pose matches a second body pose specified by the second interaction criterion. For example, as described in relation to FIGS. 1Q and 1R, the rig manipulation system 200 performs the fifteenth rig manipulation RM 15 when the user 12 has a neural body pose, and the rig manipulation system 200 performs the sixteenth rig manipulation RM16 when the user 12 has a tense body pose. As another example, in response to detecting a particular gesture, the device may perform a first rig manipulation in response to determining that the user is sitting and the device performs a second rig manipulation in response to determining that the user is standing.

In some implementations, the interaction data indicates a physiological measurement of a user of the electronic device (e.g., the first physiological measurement value 124 shown in FIG. 1S, the second physiological measurement value 126 shown in FIG. 1T or the physiological measurement 222i shown in FIG. 2). For example, the interaction data may include a heart rate measurement, a blood glucose measurement, a perspiration level measurement, etc. In some implementations, the electronic device manipulates the rig in accordance with the first manipulation when the physiological measurement is within a first range specified by the first interaction criterion, and the electronic device manipulates the rig in accordance with the second manipulation when the physiological measurement is within a second range specified by the second interaction criterion. For example, as described in relation to FIGS. 1S and 1T, the rig manipulation system 200 performs the seventeenth rig manipulation RM17 when the physiological measurement is within a normal range, and the rig manipulation system 200 performs the eighteenth rig manipulation RM18 when the physiological measurement is within an abnormal range (e.g., above the normal range or below the normal range).

In some implementations, the interaction includes a user of the electronic device holding the electronic device. In some implementations, the interaction includes the user of the electronic device holding a control device such as a stylus or a remote control. In such implementations, the electronic device manipulates the rig in accordance with the first manipulation when the interaction data indicates that the user is holding the electronic device with a first type of grip specified by the first interaction criterion, and the electronic device manipulates the rig in accordance with the second manipulation when the interaction data indicates that the user is holding the electronic device with a second type of grip specified by the second interaction criterion. For example, as described in relation to FIGS. 1U and 1V, the rig manipulation system 200 performs the nineteenth rig manipulation RM19 when the user 12 has a tight grip (e.g., the user 12 is holding the electronic device 20 or a control device firmly), and the rig manipulation system 200 performs the twentieth rig manipulation RM20 when the user 12 has a loose grip (e.g., the user 12 is holding the electronic device 20 or the control device loosely).

As represented by block 330e, in some implementations, manipulating the rig in accordance with the first manipulation includes displaying a movement of the rig in a first direction, and manipulating the rig in accordance with the second manipulation includes displaying a movement of the rig in a second direction that is different from the first direction. For example, as described in relation to FIGS. 1C and 1D, the rig manipulation system 200 moves the rig 40 in the up direction in accordance with the first rig manipulation RM1 and the rig manipulation system 200 moves the rig 40 in the down direction in accordance with the second rig manipulation RM2.

In some implementations, manipulating the rig in accordance with the first manipulation includes displaying a movement of the rig at a first speed, and manipulating the rig in accordance with the second manipulation includes displaying a movement of the rig at a second speed that is different from the first speed. For example, as described in relation to FIGS. 1I and 1J, the rig manipulation system 200 moves the rig 40 relatively slowly in accordance with the seventh rig manipulation RM7 and the rig manipulation system 200 moves the rig 40 relatively fast in accordance with the eighth rig manipulation RM8.

As represented by block 330f, in some implementations, manipulating the rig in accordance with the first manipulation includes displaying a first animation of the rig performing a first action, and manipulating the rig in accordance with the second manipulation includes displaying a second animation of the rig performing a second action that is different from the first action. For example, as described in relation to FIGS. 1M and 1N, the rig manipulation system 200 moves the rig 40 towards the user 12 in accordance with the eleventh rig manipulation RM11 and the rig manipulation system 200 moves the rig 40 away from the user 12 in accordance with the twelfth rig manipulation RM12.

As represented by block 330g, in some implementations, the rig is capable of transforming into a plurality of shapes. In some implementations, manipulating the rig in accordance with the first manipulation includes displaying a transformation of the rig into a first shape of the plurality of shapes, and manipulating the rig in accordance with the second manipulation comprises displaying a transformation of the rig into a second shape of the plurality of shapes that is different from the first shape. For example, as described in relation to FIGS. 1E and 1F, the rig manipulation system 200 manipulates the rig 40 into the open position in accordance with the third rig manipulation RM3 and the rig manipulation system 200 manipulates the rig 40 into the closed position in accordance with the fourth rig manipulation RM4.

FIG. 4 is a block diagram of a device 400 in accordance with some implementations. In some implementations, the device 400 implements the electronic device 20 shown in FIGS. 1A-1V and/or the rig manipulation system 200 shown in FIGS. 1A-2. While certain specific features are illustrated, those of ordinary skill in the art will appreciate from the present disclosure that various other features have not been illustrated for the sake of brevity, and so as not to obscure more pertinent aspects of the implementations disclosed herein. To that end, as a non-limiting example, in some implementations the device 400 includes one or more processing units (CPUs) 401, a network interface 402, a programming interface 403, a memory 404, one or more input/output (I/O) devices 408, and one or more communication buses 405 for interconnecting these and various other components.

In some implementations, the network interface 402 is provided to, among other uses, establish and maintain a metadata tunnel between a cloud hosted network management system and at least one private network including one or more compliant devices. In some implementations, the one or more communication buses 405 include circuitry that interconnects and controls communications between system components. The memory 404 includes high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. The memory 404 optionally includes one or more storage devices remotely located from the one or more CPUs 401. The memory 404 comprises a non-transitory computer readable storage medium.

In some implementations, the one or more I/O devices 408 include a display for displaying the graphical environment 30 shown in FIGS. 1A-IV. In some implementations, the display includes an extended reality (XR) display. In some implementations, the display includes an opaque display. Alternatively, in some implementations, the display includes an optical see-through display. In some implementations, the one or more I/O devices 408 include a set of one or more sensors for capturing sensor data from a physical environment of the device 400. For example, the one or more I/O devices 408 include an image sensor (e.g., a visible light camera and/or an infrared light camera) for capturing image data, a depth sensor for capturing depth data, an audio sensor (e.g., a microphone) for receiving an audible signal and converting the audible signal into audible signal data, a button for accepting button presses, and/or a touch-sensitive surface (e.g., a touchscreen display) for receiving touch inputs.

In some implementations, the memory 404 or the non-transitory computer readable storage medium of the memory 404 stores the following programs, modules and data structures, or a subset thereof including an optional operating system 406, the gesture detector 210, the interaction data obtainer 220, the rig manipulator 230 and the mapping 240.

In various implementations, the gesture detector 210 includes instructions 210a, and heuristics and metadata 210b for detecting a gesture (e.g., the first gesture G1 shown in FIGS. 1A-IV, the second gesture G2 shown in FIGS. 1A-1V and/or the gesture 212 shown in FIG. 2). In some implementations, the interaction data obtainer 220 includes instructions 220a, and heuristics and metadata 220b for obtaining interaction data that characterizes an interaction of a user in a physical environment of the device 400 (e.g., the interaction data 222 shown in FIG. 2). In some implementations, the rig manipulator 230 includes instructions 230a, and heuristics and metadata 230b for manipulating the rig in accordance with one of the rig manipulations 246 based on the gesture and the interaction data.

It will be appreciated that FIG. 4 is intended as a functional description of the various features which may be present in a particular implementation as opposed to a structural schematic of the implementations described herein. As recognized by those of ordinary skill in the art, items shown separately could be combined and some items could be separated. For example, some functional blocks shown separately in FIG. 4 could be implemented as a single block, and the various functions of single functional blocks could be implemented by one or more functional blocks in various implementations. The actual number of blocks and the division of particular functions and how features are allocated among them will vary from one implementation to another and, in some implementations, depends in part on the particular combination of hardware, software, and/or firmware chosen for a particular implementation.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

What is claimed is:

1. A method comprising:
at an electronic device including a non-transitory memory, one or more processors, a display and one or more sensors:
while displaying a rig on the display, detecting a gesture that corresponds to a request to manipulate the rig;
in response to detecting the gesture, obtaining, via the one or more sensors, interaction data that characterizes an interaction of a user of the electronic device in a physical environment of the electronic device;
manipulating the rig in accordance with a first manipulation when the interaction data satisfies a first interaction criterion; and
manipulating the rig in accordance with a second manipulation when the interaction data satisfies a second interaction criterion.

2. The method of claim 1, wherein the interaction includes a current interaction.

3. The method of claim 1, wherein the interaction includes a historical interaction.

4. The method of claim 1, wherein the electronic device manipulates the rig in accordance with the first manipulation when a time at which the gesture is performed is within a first time period specified by the first interaction criterion; and
wherein the electronic device manipulates the rig in accordance with the second manipulation when the time at which the gesture is performed is within a second time period specified by the second interaction criterion.

5. The method of claim 1, wherein the electronic device manipulates the rig in accordance with the first manipulation when a geographical location where the gesture is performed is a first type of geographical location specified by the first interaction criterion; and
wherein the electronic device manipulates the rig in accordance with the second manipulation when the geographical location where the gesture is performed is a second type of geographical location specified by the second interaction criterion.

6. The method of claim 1, wherein the electronic device manipulates the rig in accordance with the first manipulation when a number of people performing the gesture is one; and
wherein the electronic device manipulates the rig in accordance with the second manipulation when the number of people performing the gesture is more than one.

7. The method of claim 1, wherein the interaction data indicates a material characteristic of the physical environment;
wherein the electronic device manipulates the rig in accordance with the first manipulation when the material characteristic matches a first material specified by the first interaction criterion; and
wherein the electronic device manipulates the rig in accordance with the second manipulation when the material characteristic matches a second material specified by the second interaction criterion.

8. The method of claim 1, wherein the interaction comprises an utterance;
wherein the electronic device manipulates the rig in accordance with the first manipulation when the utterance is associated with a first verbal characteristic specified by the first interaction criterion; and
wherein the electronic device manipulates the rig in accordance with the second manipulation when the utterance is associated with a second verbal characteristic specified by the second interaction criterion.

9. The method of claim 1, wherein the interaction data comprises a gaze vector that characterizes a gaze of a user of the electronic device;
wherein the electronic device manipulates the rig in accordance with the first manipulation when the gaze vector is associated with a first gaze characteristic; and
wherein the electronic device manipulates the rig in accordance with the second manipulation when the gaze vector is associated with a second gaze characteristic that is different from the first gaze characteristic.

10. The method of claim 1, wherein the interaction data indicates a facial expression of a user of the electronic device;
wherein the electronic device manipulates the rig in accordance with the first manipulation when the facial expression matches a first type of facial expression specified by the first interaction criterion; and
wherein the electronic device manipulates the rig in accordance with the second manipulation when the facial expression matches a second type of facial expression specified by the second interaction criterion.

11. The method of claim 1, wherein the interaction data indicates a body pose of a user of the electronic device;
wherein the electronic device manipulates the rig in accordance with the first manipulation when the body pose matches a first body pose specified by the first interaction criterion; and
wherein the electronic device manipulates the rig in accordance with the second manipulation when the body pose matches a second body pose specified by the second interaction criterion.

12. The method of claim 1, wherein the interaction data indicates a physiological measurement of a user of the electronic device;
wherein the electronic device manipulates the rig in accordance with the first manipulation when the physiological measurement is within a first range specified by the first interaction criterion; and
wherein the electronic device manipulates the rig in accordance with the second manipulation when the physiological measurement is within a second range specified by the second interaction criterion.

13. The method of claim 1, wherein the interaction comprises a user of the electronic device holding the electronic device;
wherein the electronic device manipulates the rig in accordance with the first manipulation when the interaction data indicates that the user is holding the electronic device with a first type of grip specified by the first interaction criterion; and
wherein the electronic device manipulates the rig in accordance with the second manipulation when the interaction data indicates that the user is holding the electronic device with a second type of grip specified by the second interaction criterion.

14. The method of claim 1, wherein manipulating the rig in accordance with the first manipulation comprises displaying a movement of the rig in a first direction; and
wherein manipulating the rig in accordance with the second manipulation comprises displaying a movement of the rig in a second direction that is different from the first direction.

15. The method of claim 1, wherein manipulating the rig in accordance with the first manipulation comprises displaying a movement of the rig at a first speed; and
wherein manipulating the rig in accordance with the second manipulation comprises displaying a movement of the rig at a second speed that is different from the first speed.

16. The method of claim 1, wherein manipulating the rig in accordance with the first manipulation comprises displaying a first animation of the rig performing a first action; and
wherein manipulating the rig in accordance with the second manipulation comprises displaying a second animation of the rig performing a second action that is different from the first action.

17. The method of claim 1, wherein the rig is capable of transforming into a plurality of shapes;
wherein manipulating the rig in accordance with the first manipulation comprises displaying a transformation of the rig into a first shape of the plurality of shapes; and
wherein manipulating the rig in accordance with the second manipulation comprises displaying a transformation of the rig into a second shape of the plurality of shapes that is different from the first shape.

18. The method of claim 1, wherein the rig is associated with a virtual character.

19. A device comprising:
a display;
one or more sensors;
one or more processors;
a non-transitory memory; and
one or more programs stored in the non-transitory memory, which, when executed by the one or more processors, cause the device to:
while displaying a rig on the display, detect a gesture that corresponds to a request to manipulate the rig;
in response to detecting the gesture, obtain, via the one or more sensors, interaction data that characterizes an interaction of a user of the electronic device in a physical environment of the electronic device;
manipulate the rig in accordance with a first manipulation when the interaction data satisfies a first interaction criterion; and
manipulate the rig in accordance with a second manipulation when the interaction data satisfies a second interaction criterion.

20. A non-transitory memory storing one or more programs, which, when executed by one or more processors of a device with one or more sensors and a display, cause the device to:
while displaying a rig on the display, detect a gesture that corresponds to a request to manipulate the rig;
in response to detecting the gesture, obtain, via the one or more sensors, interaction data that characterizes an interaction of a user of the electronic device in a physical environment of the electronic device;
manipulate the rig in accordance with a first manipulation when the interaction data satisfies a first interaction criterion; and
manipulate the rig in accordance with a second manipulation when the interaction data satisfies a second interaction criterion.
